(19) United States
(12) Patent Application Publication
(10) Pub. No.: US 2016/0164450 A1
(43) Pub. Date: Jun. 9, 2016

(54) SOLAR GENERATION SYSTEMS HAVING A COMMON RECEIVER BRIDGE AND COLLECTORS WITH MULTIPLE MOBILE WEBS

(71) Applicant: Miguel VERGARA MONSALVE, Santiago (CL)

(72) Inventor: Miguel VERGARA MONSALVE, Santiago (CL)

(21) Appl. No.: 14/906,556

(22) PCT Filed: Aug. 12, 2013
(86) PCT No.: PCT/CL2013/000053

§ 371 Date: Jan. 28, 2016

(30) Foreign Application Priority Data
Aug. 6, 2013 (CL) 2293-2013

(51) Int. Cl. H02S 10/00; F01K 1/04; F01D 1/00; F02G 1/043; F01K 3/18

(52) U.S. Cl. CPC H02S 10/00; F02G 1/043; F01K 3/185; F01D 1/00; F01K 1/04

(57) ABSTRACT

The invention relates to a system for concentrating radiation in order to broaden the scale and efficiency of solar generation technologies that consist in a field of vast reflecting surfaces, in the form of collector webs, which concentrate the radiation in a common receiver bridge, which can use a thermal, photovoltaic or thermomechanical Stirling engine receiving mechanism. The collector webs hang from a structure of very tall portals and consist of mirrors adhered to a bundle of cables, forming a surface with variable topology, which can vary the shape and position thereof by stretching and tilting the support structure thereof, which can rotate to track the position of the sun. In addition, the invention provides a receiver which is installed on a bridge that runs longitudinally at height over the solar field. Each receiving mechanism offers the alternative of mobile modular receiving units such as funiculars or a stationary system adhered to the bridge in longitudinal series. The structure of the bridge supports a service access, a longitudinal area for installing thermal fluid matrix pipes and a power discharge network in accordance with the receiving mechanism installed.

### TECHNIQUE STATUS

The request herein refers to an electricity solar production system, namely, a solar radiation concentration and reception mechanism that allows a substantial improvement of both the scale and the efficiency of heat and electricity production. The system is targeted to the industrial production segment for its injection to electricity grids or the supply of network-isolated consumers.

From solar radiation, we have commercially developed three ways to produce electricity. A direct one, through photovoltaic cells, and another two through thermal and mechanical mechanisms. The thermo-mechanical conversion is performed through turbines or engines that feed a generator.

The photovoltaic technologies use inverters to convert direct current delivered by solar cells to alternating current used in mains. There are no solar field concentration applications for photovoltaic systems, only lenses or other kind of optics are used for multiple juncture cells that allow the concentration of close radiation in a small area where the photovoltaic cells are located, which are generally more efficient than the silicon ones, though significantly more expensive. Due to the small size of these cells in such systems, concentration levels of a thousand times the direct solar radiation are accomplished. Currently, this multiple juncture cells technologies is underdeveloped in the market, but there have been considerable advancements, in such a way that the experts predict that, in only a few year, the costs levels will be similar to other photovoltaic generation forms. The optic concentration implementations around the cells area currently limits the incidence radiation angles; hence, the applications performed are only used with direct sun radiation. Nevertheless, as commercial-scale applications are pretty incipient, they still have a wide development potential; hence, it is expected that this limitation will gradually decrease.

Solar-thermal technologies, on the other hand, produce alternating current and they consist of a collector system, which concentrates radiation in a receiver to turn it into heat, by heating a thermal fluid, which is transferred into a steam generation plant, with which electricity is produced through a conventional turbine-generator group. In some cases, water is heated in the receiver in order to directly produce steam for the power unit. Likewise, storage technologies have been developed, some have been tested at a commercial scale or at a smaller scale, which allow the generation of electricity at night, when there is no solar radiation.

The most developed storage mechanism consists of the installation of two storage ponds for melted mineral salts, one for hot salt and the other pond is used to store salts that have been chilled in the electricity generation process. The cycle goes from the day where these cold salts are sent to the receiver to be heated and sent to the hot salts pond. At night, the cycle is completed when the hot salts are chilled when used to feed the power circuit with heat. When the receiver does not use the melted salts directly a heat exchanger is necessary to transfer heat from the other transfer used that is being used in the receiver.

Potential performances of the technology developed and exposed in this innovation can incorporate storage systems as the one mentioned before but it is possible to incorporate other options or systems as the ones in development or in research based on thermoclines, dry storage or others being analyzed.

Currently, in the global market, there are, basically 4 technologies or types of solar thermal concentration generating plants in operation: the Central Tower, the Parabolic Cylinder Collectors ones, the Fresnel Linear Concentrators and the Stirling Dish ones. These technologies have been developed in flat sites, preferably with collecting systems with north to south alignments.

In the Central Tower system, a receiver on the top of the tower receives solar radiation from several heliostats, distributed on the solar field, which position their mirrors or reflecting surfaces according to the position of the sun to concentrate this radiation on such receiver. The design requires the consideration of significant areas that are not used, in order to avoid blockings and shadows that reduce the system's efficiency, which makes it necessary to separate the heliostats across the solar field. The receiver transmits the heat through a fluid that is heated to high temperature up to the steam generator. In some systems, the receiver heats water to directly produce the steam that mechanically starts the turbine-generator group.

The Parabolic Cylinder technology consists of parabolic transversal section reflecting surfaces lines, which concentrate the solar radiation on a receiving tube, located at the focal line of such surfaces. Through the receiving tube of each line, a thermal fluid is flowing, which conducts the absorbed heat towards a matrix tube that takes it to an exchanger that generates steam to move a turbine that mechanically starts a conventional generator.

The Fresnel Linear Concentrators technology, as the name suggests, concentrates solar radiation on a linear receiving tube located at a certain height, which transfers heat to a thermal fluid with the radiation received from the bottom, from a set of flat and parallel mirrors to the receiving tube. The mirror must rotate around a longitudinal axis to reflect sunbeams. At all times, towards the receiving tube, according to their individual position and the direction of incident radiation. The tube can carry some transfer fluid that will then be conducted to a heat exchanger to produce steam, in which case an indirect generation design must be considered, or the production of saturated or overheated steam, by directly passing water through the receiving tube, which is the most used option. A plant can consist of several parallel production lines, similar to a parabolic cylinder technology, regarding the placement of multiple reflecting mirrors parallel lines on the solar field, alongside receivers of a great length, in order to increase the production scale. In both cases, the heat transfer fluid circulation must be forced through several lines across the solar field, which restricts the maximum size of these pants, as widening the solar fields hinders the transfer of the thermal fluid used.

The Stirling-type plants consist of a reflecting dish or a parabolic mirror that concentrates the radiation on its focus, in order to produce the heat used to activate an external combustion engine group (Stirling) and a generator.

As shown in the paragraphs above, all of these plants, with bigger or smaller success, somehow concentrate solar radiation to increase the energy received and maximize the production of their electricity generation mechanism.

In general, we are able to tell that these generation systems, even though they have important advantages regarding emissions, in the current situation, their efficiency is relatively low, which leads to medium electricity production costs, significantly higher that the costs of conventional technologies and resources, such as hydroelectric plants or plants that use fossil fuels, such as coal, natural gas or the photovoltaic solar option. The main problem of carbon-based generation is its high CO₂ emission, which causes global warming, so the decrease of CO₂ emissions is an issue faced by humanity altogether. It is of the utmost importance to improve efficiency and diffusion of free alternative energies of these emissions. The advantages presented by the system discussed herein are a significant improvement of the efficiency and an increase in the solar generation production scale, in such a way that, with this technology it is possible to replace considerable amounts of carbon generation to reduce CO₂ emissions and significantly contribute to the solution of the global warming problem.

The concentration mechanism developed in this invention is comparable to each one of the existing solar thermal concentration technologies in the market, according to the following:

It is similar to the central tower technology, as it consists of a receiver in a very high position, where radiation is concentrated from a solar fields where structures that gather mirrors groups are installed, with a sun-tracking system to carry this radiation through the daily cycle and the seasonal variations, in an exact way, up to the collector. In both technologies, heat transfer fluids do not have to be pushed across the solar field, as this must flow through the receiver, at a high altitude, up to the storage system, if any, and up to the energy production plant, setting the solar field free of this function. On the other hand, it differs from the central tower system, where the receiver is excessively concentrated, hindering the collectors' functions. With this new system, the radiation transfer to the receiver is facilitated, which is also located at a high position but, as it is longitudinally prolonged on the solar field, it reduces the chances of blockings and shadows, and the need to maintain angular positions that are too open in the collectors, allowing the improvement of energy collection scale and efficiency.

Regarding parabolic cylinder technology, it is similar when a curved surface form is used to concentrate energy on the reception area. In the parabolic cylinder, the radiation is concentrated on the collector's parabolic surface focus and sun-tracking is performed by rotating this surface in a supportive form with the receiving tube, not requiring or allowing changes on the collector's shape. In the invention system, the receiving system position can be changed, as well as the shape of the reflecting surface (which corresponds to a catenary curve) of every collector, which grants additional freedom levels to center radiation on the receiver area, avoiding bigger blocks or shadows between collectors. The most important differences between both technologies are the larger collection scale of the invention system, and the fact that an independent receiver system is used, which is out of the solar field, which leads to a considerable reduction of the solar field cost. Likewise, the resulting receiver has a larger scale and it reduces the disadvantages of a receiver distributed on a wide area that increases the heat conduction and dissipation problems, as it happens with the parabolic cylinder, distributed across the whole solar field, which restricts the size or scale of such technology.

Additionally, regarding the other technologies, the system of this invention in its solar thermal application significantly facilitates the use of melted salts as a thermal fluid, as well as the use of the direct steam generation option. In both options, the incorporation of thermal storage is also enabled.

Another important advantage of this invention, against the rest of the known technologies, is the possibility to efficiently use land with big slopes and variable topography with several orientations. The slopes enable the establishment of collection webs at different heights, upwards, towards the high areas of the hills, without blocking each other. They do not have to be arranged in a line as the Parabolic Cylinder ones or in a Fresnel Line, as, with an extended receiver, the webs orientation possibilities are generated towards several portions of the receiver, avoiding blockings or shadows issues with neighboring units.

### FIGURE DESCRIPTION

FIG. 1 shows a perspective of a group of collectors with a wide view of a collector Unit or a Mobile Web.

FIG. 2 shows a second execution of a collecting web with 4 collecting webs or surfaces hanged on the same double-portal structure, frontal view.

FIG. 3 shows the collecting web of FIG. 2, from the back.

FIG. 4 shows the plant of a collecting web in a lying position.

FIG. 5 shows the profile of the collecting web in FIG. 4.

FIG. 6, at the lower circle, shows a longitudinal profile of a typical hanging bridge to support a common receiver at height. On the upper area, there is a panoramic picture of a solar field with the collecting webs facing a receiver at height.

FIG. 7 shows a maintenance and transfer station for maneuvers with support cabins (300) for the receiving units, which correspond to a modular receiver with moveable cabins. Four cabins are shown with open lids. They hang from the hanging bridge that allows them to slide up to their operation position.

FIG. 8 shows a closer vies of a cabin and a portion of the bridge, indicating its main elements.

FIG. 9 delivers more details through a transversal profile of a cabin and its suspension anchor form the rails, showing the wheels (306) required to slide and move across the bridge.

FIG. 10 shows a second view of the cabin, from the right.

FIG. 11 shows a transversal cut of the receiving system, in its longitudinal version with a secondary collector. The receiving tube (402) is in the center, under the track, with the secondary collector around the bridge.

FIG. 12 shows the secondary collector and the receiving tube in a tridimensional view from the right side.

FIG. 13 shows the execution of a longitudinal receiver with receiving modules on the outer area of the supporting structure, which can spin with the bridge in the center, in order to bring the receiving modules closer to the mounting and exchange area (510) on the upper part of the bridge.

FIG. 14 shows a longitudinal profile of two portions of the bridge with their respective longitudinal receiving modules (505). The figure shows how the receivers are joined to a circular collector (508) on every edge. At the center, there is a joint between the two circular collectors that links two successive sections.

FIG. 15 shows more details of the receiving modules of FIG. 13, subdivided into groups if 6 tubes in a line, sectioning the clear cover by groups of tubes.

FIG. 16 shows a variant of the collector of longitudinal modules in FIG. 13, which can rotate, supported on the upper part of the bridge, for its mounting and maintenance.

FIG. 17 shows a section of the receiver for the photovoltaic option.

FIG. 18 shows a tridimensional picture of the photovoltaic receiver shown in FIG. 17.

FIG. 19 shows a portion of the layout of a receiver with photovoltaic cells that allows the decrease of the incidence angle variation range for each cell, using a fractal-type structure.

FIG. 20 shows a heat to electric energy phased transfer chart using several Stirling engines for several temperature ranges.

### DETAILED DESCRIPTION OF THE INVENTION

The invention herein seeks to improve the solar radiation concentration and reception mechanism to increase the scale and efficiency of either the photovoltaic production, the steam and electricity solar thermal one, the Stirling engines one or any of their combinations. In this way, a significant cost reduction is sought regarding the investments to improve competitively in this kind of resource, in the face of conventional electricity production plants.

The technology consists of a solar collecting field composed by wide collecting surfaces, which are used as wide reflecting webs (101), which hang from a high portals (103), with a mechanism to adjust their curvature to concentrate the radiation on a Common Receiver Bridge area, also at height.

The solar field is composed by multiple mobile webs, which reflect radiation towards a single Common Receiver Bridge at height, typically supported by a hanging bridges structure, which transfers radiation to a power system based on either photovoltaic units, in solar thermal units, or a Stirling engines one, or a combination of both. Alternatively, a portion of the heat can be transferred into a thermal storage system for its subsequent use in generation, in the periods where there is no solar radiation.

The invention focuses on the development of structures and configurations, different than the ones known in the solar industry, regarding collecting and receiving systems that seek a greater size, efficiency and flexibility to adapt to different topographies and local conditions to develop several kinds of solar systems. In a complementary way, automatic washing mechanisms for mirrors have been incorporated to avoid efficiency loss due to the impact of pollution or the presence of suspended dust in the solar field, which can be relevant in many places. In addition, certain favorable topographic characteristics that could be presented in a certain site can be exploited to increase height and the capacity of installations, improving both the production scale and the efficiency of such systems. As far as possible, the option of modular structures has been used to enable its serial production and the reduction of investment, replacement and maintenance costs.

A) Multiple Mobile Webs Collector (SC-MVM) Description

The basic unit of the mobile webs collector is a wide and flexible collection surface, hanged as a big web (101) and formed by an armor made of a cable network on which many lines of flat mirrors, or other types of reflectors, as convenient, are hanged. Within every line, the mirrors, with or without metallic frames, are fixed on bars or transversal cables tightened from the edges to two consecutive cables of the armor through tensors and shackles. Between the neighboring mirrors, enough room is considered so these do not break or get damaged when the armor is moved. Likewise, the mirrors are firmly attached on one fixation only, making the others flexible enough so these are not subject to mechanical efforts, beyond its resistance.

Thus, every web, or collecting surface, is formed by the subsequent addition of transversal rows of flat mirrors, held by the longitudinal and transversal cable network armor, which form a flat and flexible weave that can reach great dimensions.

This structure allows the adjustment of the web curvature by tightening the longitudinal cables, without subjecting the mirrors to unbearable efforts, as these hang through sliding plastic joints, with metallic bearings. Likewise, the bearings are attached in transversal lines and they are held by cables or flexible metallic rods that absorb the tension, to avoid efforts on the mirrors, derived from tightening.

The collecting web structure can be used directly for the generation of electricity by replacing the mirrors with photovoltaic panels and by adding conductors to carry electricity to inverter substations through pipes attached to the armor cables. As mentioned below, both the collecting webs support structure and the mechanisms to adjust their shape and movement allow the establishment of big solar collection areas with great efficiency, making it more competitive that the existing configurations.

Collecting Webs Configuration

The collecting webs have been set up as an endless surface (101), similar to a conveyor belt, which is supported and moves through suspension and tightening drive rollers (104). To do this, the ends of each longitudinal cable in the armor are joined together. Thus, the web is closed around itself in a continuous structure and surface that can be moved by sliding the longitudinal cables on the rollers, dragging with them the transversal mirror lines that form the continuous reflecting surface. The web has two types of surfaces, a portion exposed to solar radiation and return portion, which is not exposed to radiation. This actuation and double-surface mechanism, with a drive rollers system (104) located at the suspension portal has a series of operational advantages. Such advantages include the following:
Easy assembly and replacement of mirrors

To mount mirrors, it is only necessary to bring the web transversal lines closer, through the traction system through rollers (104), one by one, to the assembly and replacement area, which is generally located at the lower area of the web.
Keeping a backup mirrors surface in the area that is not exposed to radiation

The lower part of the web, or the return area under the area exposed to radiation can have bare armor wires, with no mirrors, only to provide continuity to the movement mechanism. Alternatively, this portion can be used with additional backup mirror lines, mounted in the same way as the exposed area, which would double the mirror surface of every web leaving half of the backup mirrors available in case they are needed. For the backup, it is only necessary to move the backup area to the upper position or the portion exposed to radiation. This operation would allow the replacement of the reflection surface, halfway through the day, by a backup surface with dean mirrors
Adding photovoltaic panels to a portion of the web

In case of radiation excess, and for the time where focusing on the receivers is more difficult, it could be convenient to add photovoltaic panels in a portion of the web. This mechanism allows the reduction of the portion of the web intended for the receiver at height, without losing the radiation that could overfill the collector.
It enables the incorporation of an automatic wash system for mirrors or photovoltaic panels

The washing mechanism is installed on the lower part of the web to simultaneously cover a full transversal mirror or photovoltaic panel line. By activating the belt's traction system, the lines can be washed successively, one by one, until all mirrors or panels of the web are fully covered. This operation can be performed at night or continuously and automatically during the day, if necessary, which maintains a high reflection efficiency even in high-pollution sites.
Keeping different mounting angles for different web sections

In some cases, it could be convenient to count on a different mirror or panel mounting angle for some hours of the day. In these cases, different mounting angles can be maintained for several areas of the web and they can be oriented towards the reflection areas at the appropriate time.

Support Structures for Collecting Webs

The width of the web is hanged from a wide suspension portal at a great height, through supporting rollers (104) through which longitudinal cables of its armor slide. On the lower portion, in a low position with horizontal movement from the portal, there is an independent and isolated structure, with a roller system on a horizontal bar, which tightens the web to create a descending curved surface, which allows the concentration of reflected radiation, in a receiving area.

The suspension portal can adopt several shapes. To expose its functionality, this presentation describes the design of two parallel portals mutually detached and tilted towards each other, in such a way that the rods (103) of every side are crossed in scissor shape, both mounted on a common spinning base (102). The web (101) is supported on rollers (104) that spin supported on both horizontal bars of the portals and on the traction and anchoring bar of the lower rail (106). The tightening and wiring of the web is modified by opening or closing the portals with hydraulic mechanisms supported on lateral rods of both portals. Respectively, both lateral rods of one of the portals press on the others rods, making it rotate to move the horizontal bars that support the web. With this mechanism, the portals can be takes from one position with the active face in a practically vertical position to their maximum position, in which the web is on lying position, more stretched and with a smaller tilt In this tour, it may be necessary to stretch one of the portals to reach the required web tightening. Then, both the opening control of both bars and their height adjustment allow the regulation of the tightening of the web, during its continuous movement, following the position of the sun throughout the day.

The portals are supported by a common base that can spin freely, in such a way that these can rotate together around their central pivot (105). Thus, if the supporting anchors on the lower are of the web (106) are moved, the height portal will follow the movement by spinning the full structure towards the new orientation, without deforming the web surface. The anchors on the lower area slide through horizontal circular rails (106) whenever the web is to be rotated, keeping its shape and tension.

Due to its weight and flexibility, when the web falls, it has a catenary form. In a transversal direction, the web stays fully unfolded presenting an approximately straight line. Thus, by adjusting the longitudinal tension of the web, the orientation and position of anchors and bars, the orientation and catenary shape can be changed so it concentrates radiation on the receiver area. This, at all moments, happens as the sun moves in its apparent displacement on the solar field. It is necessary them to have a tracking computer mechanism that performs the tightening and position adjustments required of the supporting rollers.

An additional incorporated mechanism us a group of linear loads (107) placed on some transversal web wires to break its curvature and differentiate sectors that, even though they still individually have a catenary shape, as a set they differ from this shape, which can be useful as a tool to focus radiation with a higher accuracy within the receiver's area, in certain moment throughout the day. In this way, differentiated catenary sections are formed among these lines. Specifically, these elements consist of tubes, placed across the width of the web, which are filled with some heavy liquid that is extracted or added as necessary, to increase or decrease the necessary load on that line.

Collecting Webs Movement

The tracking system, adjusting the tension and position of the anchors of every web, performs movements on two axes or two types of collecting webs movements:

1) Horizontal sun-tracking movement

These are movements of both the bars and the anchors, on a horizontal plane, in order to maintain the curtain on front of the sun, without altering the shape of its surface. This is a synchronized movement that corresponds to a spin of the curtain on a vertical axis. The movement is similar to the spin of an office chair.

In this movement, the upper portal spins freely around its base (102) adjusting the orientation in a forced way, following the movements of the anchoring system when moving on its lower circular rails (106). The tacking system can only control the movement of the lower anchoring rails, as the upper one will follow the movements of the former when producing an unbalance of forces exercised on the wires at both sides of the web. Nevertheless, due to considerations of a greater control of the webs spinning, it is recommended to incorporate a circular zipper-like mechanism with activation through electric motors to make the common base of the suspension portal spin.

2) Focus adjustment movement and sunrise tracking.

These are movements to adjust the surface shape to the catenary which enables the concentration of radiation reflected within the receiver's area. This is a continuous and synchronized movement regarding the opening and position of the suspension portal bars to adjust the shape and tilt of the collecting web, changing its topology throughout the day, as the sun rises, turning backwards or onwards, in order to reach a reflection angle that matches the receiver's area. This movement is similar to an office chair when the user leans backwards spinning around a horizontal axis, transversal to the web, without spinning around its vertical axis. In those designs that incorporate variable linear loads in certain rows of the collecting web, a small adjustment can be made to the shape of the web by controlling the weights of the loads.

3) Additional adjustment movement for the tilt of horizontal lines within each web.

For very accurate requirements of the panels' horizontal lines individual focus, an automatic sun-tracking mechanism can be added, independently for each line. This could be the case when using webs for direct generation through photovoltaic panels that use optic radiation concentration means in multi-layered cells, in which the angle must not differ more than half a degree from the vertical layer. In order to do this, every panel must be anchored on a base or frame, which can have different angles according to the wire network. Only a small adjustment of a small angle is required as both previous movements 1) and 2) perform tracking with quite high accuracy.

Distribution of Collecting Webs on the Solar Field

In flat or uniform slope topographies, the longitudinal receiver enables the consideration of identical collecting webs, of equal size, arranged in several parallel rows, virtually net to each other, in front of one or both sides of the receiver. With significant slopes, it is practically not necessary to leave room between every row, it is only necessary to ensure that the collecting webs design considers that these can be elongated or lowered to cover certain areas, if necessary. Likewise, the supporting structures can be lowered to avoid blocking, when the time makes it possible and convenient. Depending on the tilt of the sun at some points of the day, some collectors are not working or only a portion of their surface is working. This is the case, for example, of linear receivers distributed from north to south, with slopes on its both sides, early morning, at sunrise, with low elevation angles, where only the first collector on the west are working.

In the case of topographies with slopes or variable height, an ad hoc design is required to take advantage of the promontories and hill, the use of several collector sizes may be convenient, as well as a variation in the layout of rows and columns used in more uniform topographies, In all cases, the design of the collector cannot be executed independently from the receiving system. It would then require a global design of the plant facilities, with all subsystems, looking for a whole optimal design. Obviously, a place where significant heights are available for anchoring wires or suspension structures of the Receiver Bridge, as well as slopes where many rows of collectors can be placed, one behind of the other, will have unquestionable advantages regarding efficiency and investment cost, resulting in a more competitive mean final energy cost.

Protection of Collecting Webs Facing Danger of Strong Wind

The supporting portal structure describe before allows the collecting web to go lower at levels close to the ground, in case strong wind or other dangers are foreseen, which could risk the integrity of mirrors and supporting structures.

B) Common Receiving Bridge Description (PRC)

In the solar field concentration technologies, it is expected for the receiver to receive a radiation level quite above the direct solar radiation. Thus, the receiver must offer an efficient and intensive power transformation mechanism to enable its transfer to the plant, the storage units or the supply network consumers. The Common Receiving Bridge of this invention is compatible with 3 reception mechanisms for high-concentration radiation, namely: mechanisms based on solar thermal, photovoltaic or electromechanical processes.

Currently, at this intensity level and scale, there are only solar thermal receivers that transfer the radiation received, as heat, to a transfer fluid that circulates inside it. The receiver is integrated to a hydraulic system to feed the power system and, in some cases, also to thermal storage units.

The system developed in this invention substantially improves the efficiency and scale of the solar thermal reception systems and, additionally it incorporates, to the receiver, the photovoltaic and electromechanical reception mechanisms that restricted its commercial application to non-concentrated direct reception mechanisms. Particularly, the electromechanical mechanisms added consist of Stirling engines that receive heat and feed synchronic generators, delivering power in alternating current. On the other hand, the photovoltaic ones directly turn radiation into power, but they must incorporate inverters to transform the generated continuous current into the alternating current compatible with the power network. In this invention, photovoltaic systems using both the concentration field mechanism with collecting webs with wide reflection surfaces and the optical implementations developed close to the photovoltaic cells are conceived.

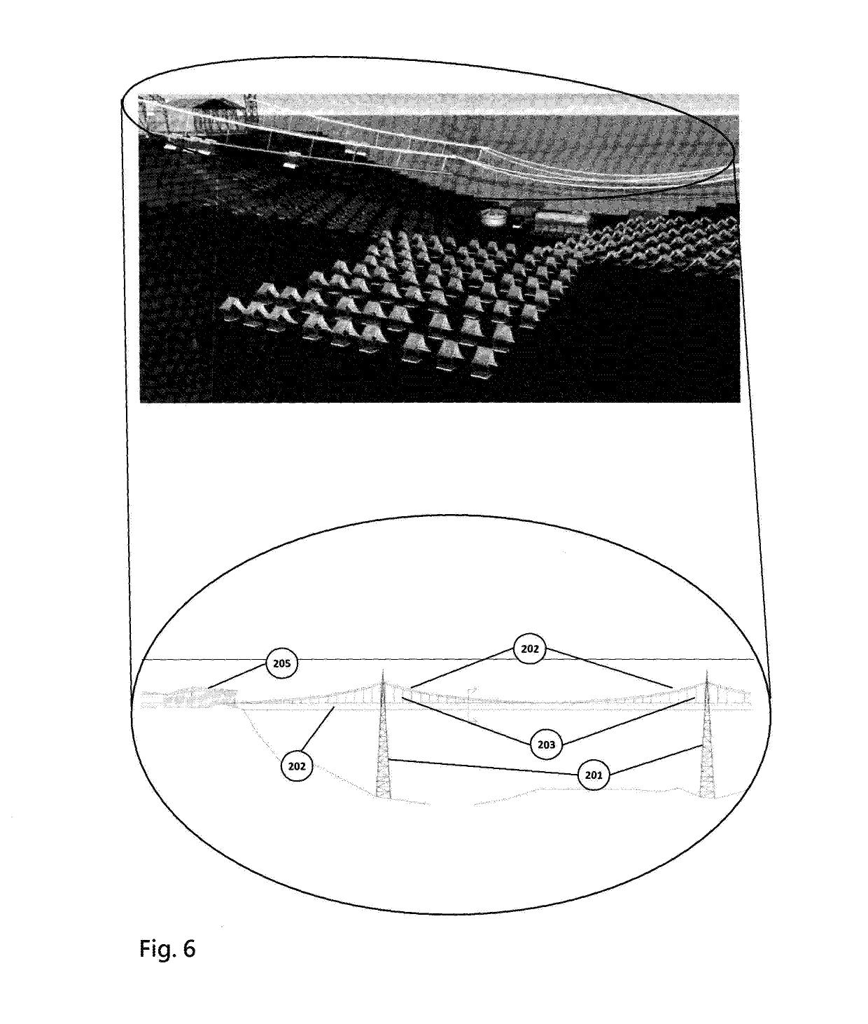

Structurally, the receiver of the system herein is a configuration of the single receiver, which can have one or several receiving lines (FIG. 6), but it is also common for all, or big areas, of the solar field. Hence, the receiver is set up independently in order to receive radiation from all collecting webs on the solar field.

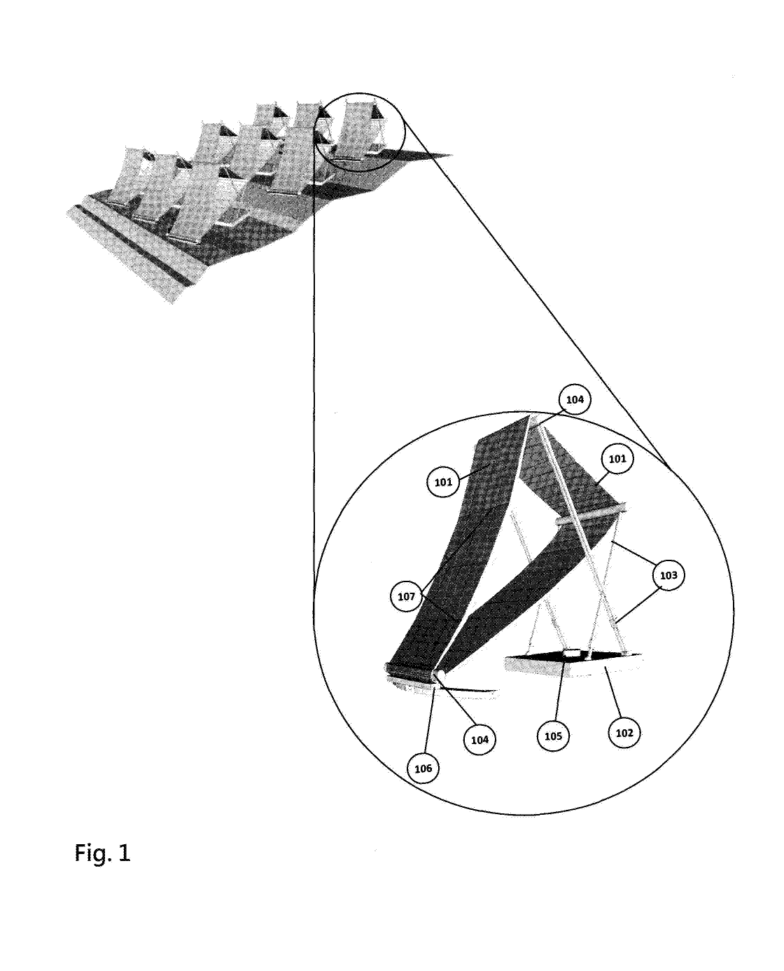

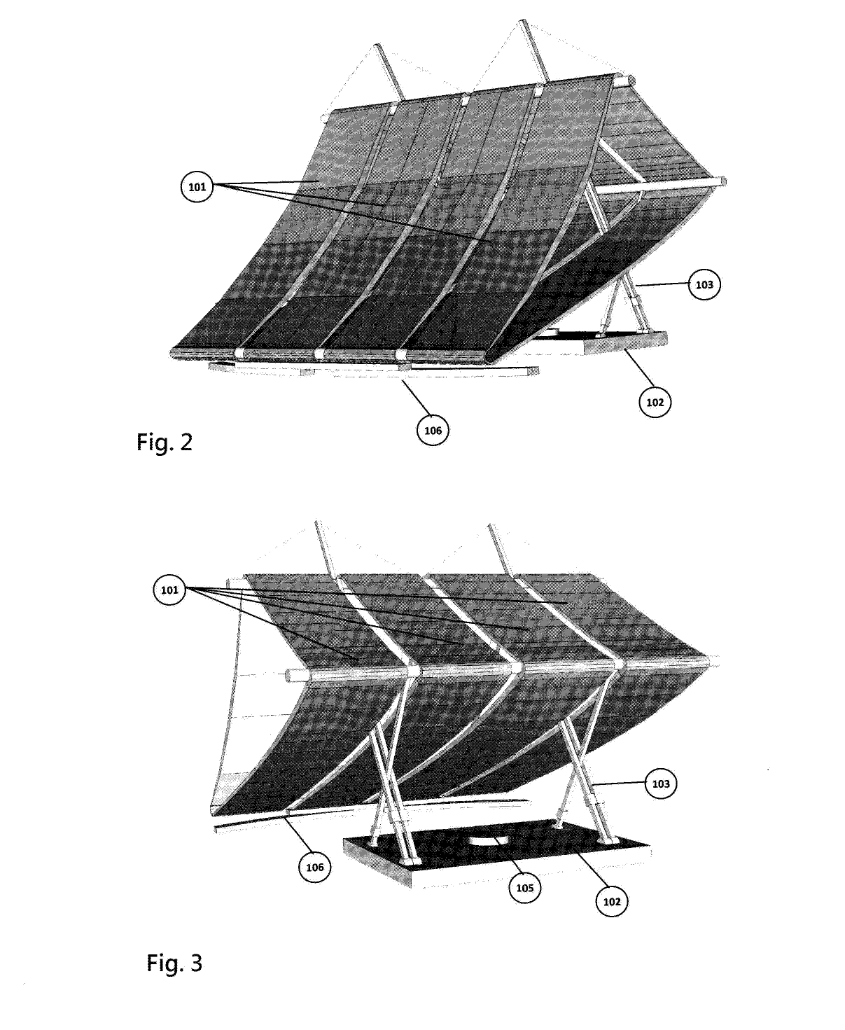

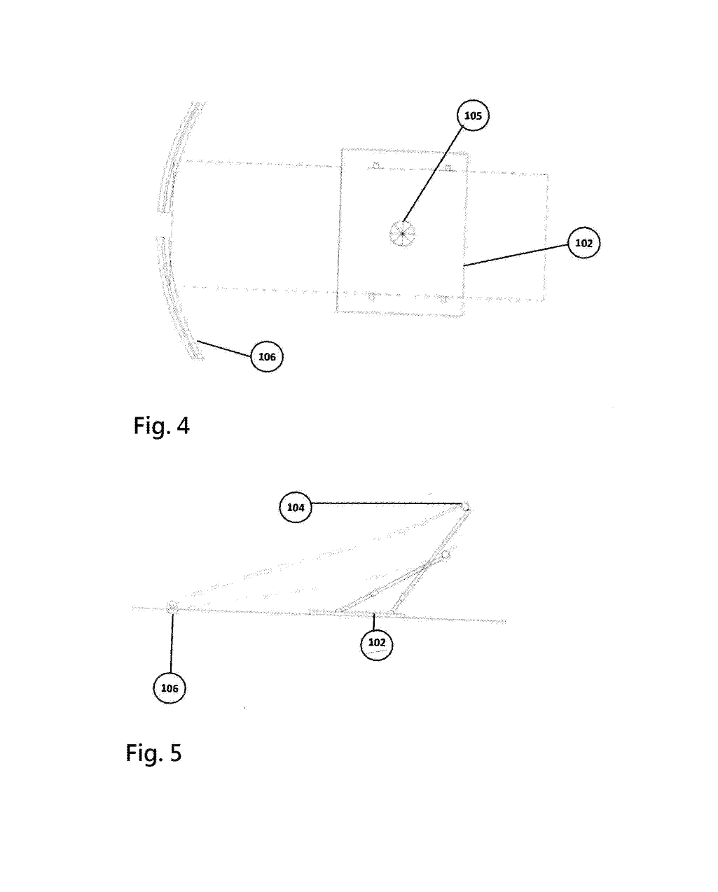

A second characteristic of the receiver is its location at height on a structure of bridges (FIG. 6) which goes across a considerable length of the solar field. A hanging bridges set up suspended on a wire network (202, 203) is considered preferable, supported on structures on high hills and towers of great height (201). The greater heights enable the reception of radiation coming from multiple collecting units (FIG. 1), located at several sectors of the solar field.

This receiver, at a great height, separated from the collecting webs solar fields and with higher concentration in its installations, has a series of advantages, including the following:
It allows a higher production scale. By operating considerable nigger collecting surfaces that the ones in the existing systems.
It enables intensive photovoltaic generation by using the solar field generation to reduce the number and area of photovoltaic cells to employ for the same generation capacity.
In the thermal solar case, it facilitates the steam direct generation option, as the piping required to conduct steam are confined to the receiver's area, much smaller than the one covered by the solar field.

It enables the use of melted salts as a transfer fluid and storage means. The receiver in an delimited area unattached to the solar filed allows the use of a simpler minimum temperature control mechanism to avoid solidification of salts.
It enables the use of higher temperatures in the whole system, as it works with higher radiation concentrations in a narrow area without extending the conduction pipes too much. Higher temperatures have the advantage of improving storage capacity and steam production, also reaching a higher efficiency in the thermodynamic cycle of the solar-thermal plant altogether.
It enables the use of Stirling engines in the receiver with a higher capacity than the one currently obtained from parabolic dishes, by receiving concentrated radiation from the solar field.
Likewise, it makes it possible to use air as thermal fluid at high temperatures to feed a Brayton thermodynamic cycle and, with the remaining heat, generate steam for the other power unit, setting up a solar-thermal combined cycle.

Below, the Suspension and Anchoring Structure of the receiver is described in detailed, as well as several installation configurations for specific structures of the bridges, which are common for the three reception mechanisms and, finally, the specific characteristics for the solar-thermal, photovoltaic and electromechanical mechanisms. Likewise, Secondary Collector executions are presented, for setups where the width of the reception area is too narrow and, thus, it is necessary to include additional installations to capture the radiation overflowing such area.

a)Suspension and Anchoring Structures of Common Receiver

The receiver is actually installed on a set of high bridges. Preferably, a hanging bridge system supported by high towers or structures located at high places is considered, in order to reach a great height without additional expenses, looking to accomplish narrow reception areas with a great length.

A hanging bridge is a simple way to hold a longitudinal receiver at a great height. FIG. 6 shows a receiver installed on a hanging bridge supported by two distant towers though wires that hold it. In variable topography sites, the high surfaces must be exploited, in order to provide continuity and connectivity to the bridge installations towards the rest of the plant. In flat sites, the connection can be performed through vertical pipes and elevators or through an access bridge system with slopes, until reaching ground level.

There are hanging bridges in many roads around the world, with huge load capacities and length. Comparatively, the application presented in the invention herein has much less requirements that these bridges, because the loads to support by the bridge in this case are smaller and because the wind loads can be considerably reduced. This is a result of the bridge structure not necessarily requiring walls or continuous surfaces that could create considerable resistance that result into significant design restrictions. Thus, technically there are no greater limitations to implement this new setup of receivers distributed across long hanging bridges.

Even so, it must be ensured that the hanging bridge for the common receiver considered, other than containing the feeding pipes and valves, as well as the receivers constitutive elements, is able to provide access and services for mounting, replacement, maintenance and operation of the receiver and the secondary collector, which also must reside within the bridge structure. The access and transportation needs within the bridge (207) for the elements mentioned above makes it necessary to use people and material transport cars, washing machines, forklifts and other similar vehicles. Thus, rail lines must be established, preferably two-way lines, with transfer areas within the bridge.

Likewise, this setup must provide services such as compressed air, water, strength, lighting and mirror washing services. In case of establishing a receptor with photovoltaic units or with Stirling engines on the bridge, it must be considered that the wires that carry power to the power plant, which contains the inverters and rigor control elements must also go through the bridge. All in all, the bridge loads are considerably smaller than highway bridge loads.

In general, a bridges setup with significant operational advantages has a transport route on the upper part and the receiver system on the lower part. Metallic arches, regularly distributed across the bridge, integrate the structure and provide the anchoring and suspension elements required from the supporting vertical wires from the top. In order to avoid an increase in wind lads, it is recommended to have an uncovered road, with no continuous surfaces such as ceilings, walls or floors. This has an additional advantage, it does not cause significant shadows on the solar field.

Just as a hanging bridge, a set of primary wires joins the upper ends of the towers that support t, hanging from them in a catenary shape (FIG. 6). From these catenaries, vertical wires supporting the metallic arches of the bridge structure from the top are hanged at regular distances.

Interesting variables that depend on the solar field topography may make it convenient to increase the number of towers or support structures on hills or promontories. That is how the most complex setups with curved reception lines enable the adjustment and dedication of certain receiving lines to specific areas of the solar field in order to facilitate sun-tracking by collecting systems, accomplishing a higher efficiency regarding the capture of radiation and increasing the scale of solar plants. A receiver at height with curvatures towards specific areas allows the collectors to focus on that area, also reducing unused areas around the solar filed, and the collectors do not have to be too far from each other when the plant is widened. Thus, in the case of sites in abrupt topographic areas with relevant slopes, the design must be executed according to the specific conditions of the installation areas, placing some or all anchoring towers or structures of the Central Receiving Bridge on top of the hills, extending towards the valley making its layout facilitate reception.

Several receiving lines, with a certain curvature and concavity for specific areas each, enable the adjustment and tracking that the collecting webs must perform to maintain positions with low reflection angles. Each area can correspond to a different orientation or topography within the solar field. Several curved lines can close one another, which creates closed circuits that facilitate the transport of materials, with common storing sites and cars or funicular cabins transfer stations.

b) Receiver Setups applicable to the three reception mechanisms

The reception system is placed on lines that go into the solar field to receive radiation from many collecting webs, The execution of several types of solar generation mainly differ in the fact that the photovoltaic and Stirling engines options in the generation facilities must be placed in the receiving bridge itself, which requires an evacuation electric network towards the plant elevation substation. On the other hand, for the solar-thermal option, the power is transferred as heat, through a thermal fluid, to a plant with steam turbines or eventually to a gas turbine or a Brayton cycle turbine, Thus, in this last case, it is necessary to incorporate matrix piping through the bridge, in order to carry the fluid at a high-temperature to the generation and storage plants. It is then possible to establish thermal fluid piping or a power evacuation network through the bridge, depending on the type of reception mechanism to be established.

For the options that consider the generation within the bridge, as the photovoltaic and the Stirling engines one, it is necessary to consider an electrical network for its evacuation. In the photovoltaic option, the inverter substations with the required switches and transformers must be considered as well. Similarly, in the Stirling engines option, all required element for the incorporation of its production to the network must be incorporated.

In turn, there are several receiver setup options, some of them consider fixed unites pinned to the supporting bridge and others incorporate mobile units options that can slide through the bridge, adjusting their position throughout the day to facilitate the focus from collectors. All these options consider modular units to facilitate their mounting, replacement and maintenance.

For fixed units, the option of the receiver being on the central part of the bridge structure is considered, as well as developing the receiver around a wider structure in order to widen the reception area. In the first case, a secondary collector is incorporated to widen the equivalent reception area. In turn, two mobile options are considered, consisting of either funicular-type hanging cabins or a cart trains containing the reception mechanisms, which can move across the bridge, All these options can be used with any solar reception mechanism mentioned above, and they are described in detail below:

i. Longitudinal Interior Receptor with Secondary Collector

It consists of a narrow receiving line with higher concentration located at the central area and under the service rail for the bridge. The line is subdivided in modules related to specific sections of the bridge and they can be connected either in series or parallel. It is incorporated around the receiver in a wide area of secondary collectors (400), which consists of radial reflecting areas, mounted on a structure around the bridge, in order to capture radiation that overflows the receiver, This structure, mostly described in section “c) secondary collector”, is very important as it allows to considerably widen the width of the equivalent reception area to have enough clearance and improve the focus and concentration possibility of the collecting webs towards the reception area, while tracking the position of the sun overtime. On the one hand, a narrower reception area has the advantage of having a more efficient receiver but it forces the consideration of more accurate tracking and concentration systems, which are more expensive. The secondary collector presents a large collection surface with receivers of smaller opening, which makes them more efficient.

The Secondary Collector

The function of the secondary collector (400) is to widen the reception area to capture radiation to overflow the receiver as such This collector receives radiation from the solar field (FIG. 1) in the same direction, either throughout the day or throughout the year. Thus, it does not require a sun tracking system, as the case of collector webs that must move when adjusting their position and shape according to the sun apparent movement. For this task, the secondary collector surrounds the receiver (401) capturing the sunbeams that usually escape, redirecting them towards the receiving surfaces. There will be a radiation overflow either due to misalignments in the sin tracking system of the collecting webs, vibration because of wind or other disturbances from the collectors or the receiving bridge.

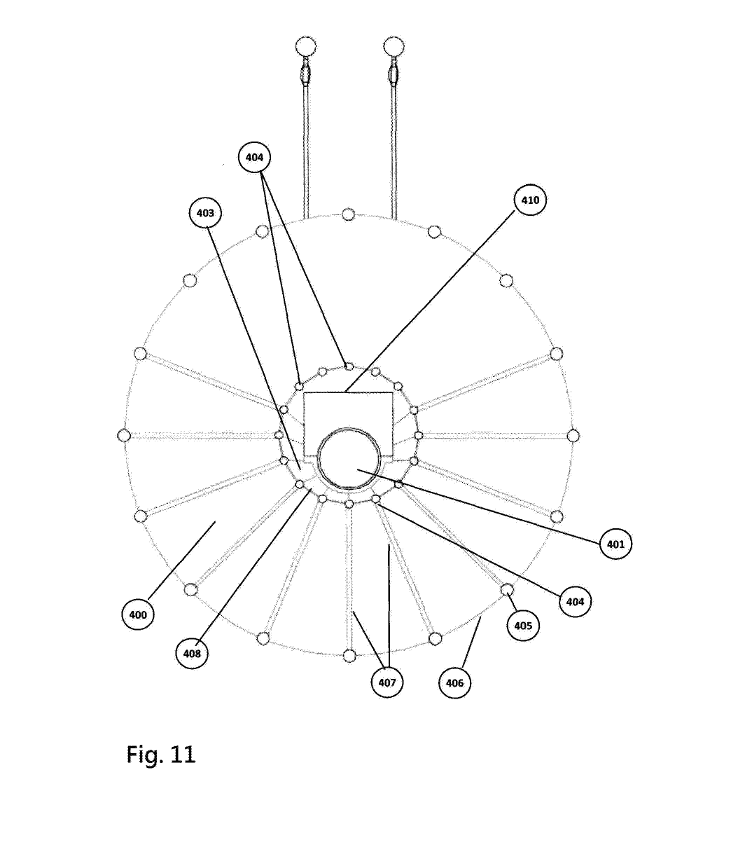

The secondary collector's setup proposed in the invention herein consists of mirrors or reflecting surfaces placed on the plane formed by the longitudinal and radial directions supported on independent structures per section. These structures surround the bridge, in the corresponding section, and they are developed between the radius surrounding the bridge (408) and a far external radius (406) that outlines the collection limit, acquiring the form of a squirrel cage (FIG. 11) with longitudinal bars (404, 405), with uniform clearance, om two concentric cylindrical surfaces, joined by rings (406) that provide robustness and allow it to spin on circular rails places on the structure of the bridge.

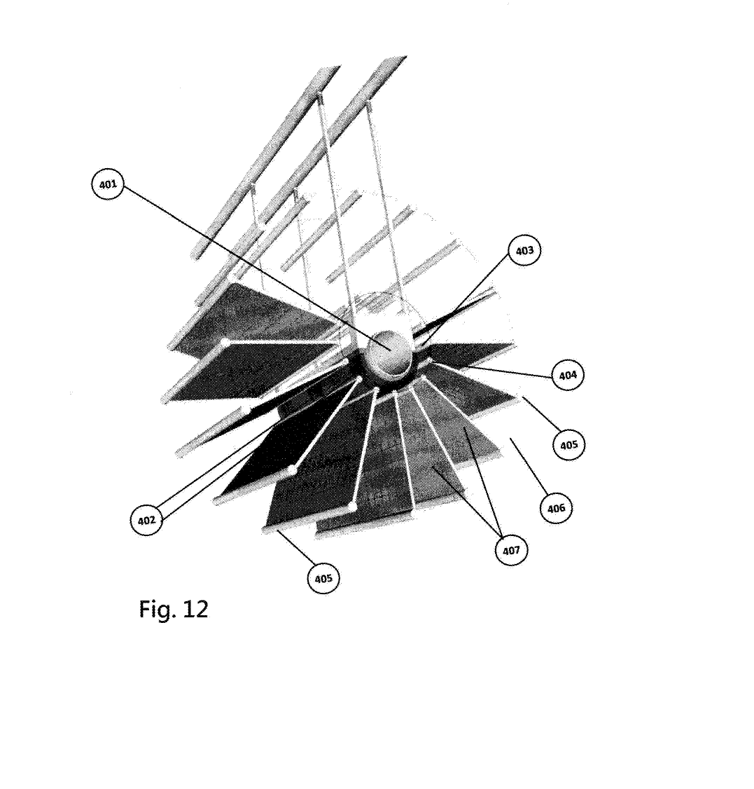

The collector as such consists of double-mirrors rows (407), with both reflecting faces, which are held by a wire network, through shackles, which fixed to the external and internal bars of the cage, in a radial direction. Once the mirror rows are mounted, the cage looks like a horizontal cylindrical turbine (FIG. 12), where the mirrors surfaces look like blades in a radial direction. The support structure on a squirrel cage shape described allows the placement of mirror surfaces in angles different from the radial direction by joining the external bars with bars displaced from their radial twin line. Likewise, it is possible to create broken surfaces to obtain certain concavities that enable a better targeting of radiation sunbeams through the mirrors towards the receiving areas.

The secondary collector is then developed in a radial way on its squirrel cage structure, being able to rotate around the bridge, which allows one of the mirror rows of the collector to get closer to the mounting, maintenance and cleaning positions from the upper part of the bridge (410). Additionally, the rotation freedom delivers the benefit of reducing the wind loads over the whole collector bridge.

ii. Peripheral Longitudinal Receiver with no Secondary Collector

This option considers an alternative solution to the incorporation of the secondary collector to widen the area towards which the collecting webs of the solar field must target radiation. On the upper part of the bridge, a mounting area is established (510), which is implemented with hoisting mechanisms to take modules or elements from the transport and supply carts and take the, to their work positions. The receiving modules are mounted on a cylindrical structure with the shape of a squirrel cage that can rotate with the bridge in its interior, in order to enable mounting, the replacement of parts and spare parts, as well as maintenance. When rotating the squirrel-cage structure the mounting lines come closer, one by one, to the mounting area in order to perform the corresponding tasks. We have tried to setup the receiver elements in exchangeable homogeneous modules to simplify operations.

This setup divides the receiver into sections or coincidental longitudinal modules with the bridge spans (distance between suspension arches that hang from the vertical suspension wires (203)) to enable the rotation mentioned before and so it is not blocked by suspension wires (203).

Thus, the receiving modules (500) of every section of the bridge, even though they are fixed to operate, in all reception mechanisms, are exchangeable and positioned in such a way that they can be mounted and then replaced when necessary in the mounting area, on the transport or service rail of the bridge. These longitudinal modules can operate in series with joints between them or independently in parallel connecting between each other, either to the matrix piping or the power evacuation network, as necessary.

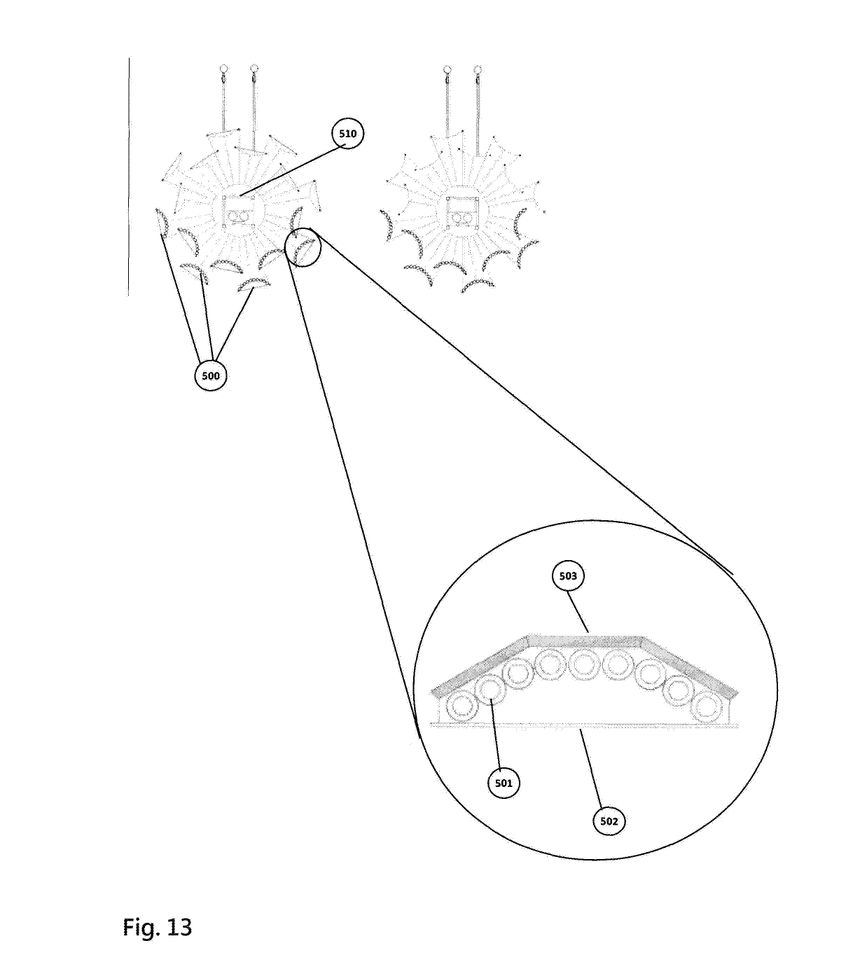

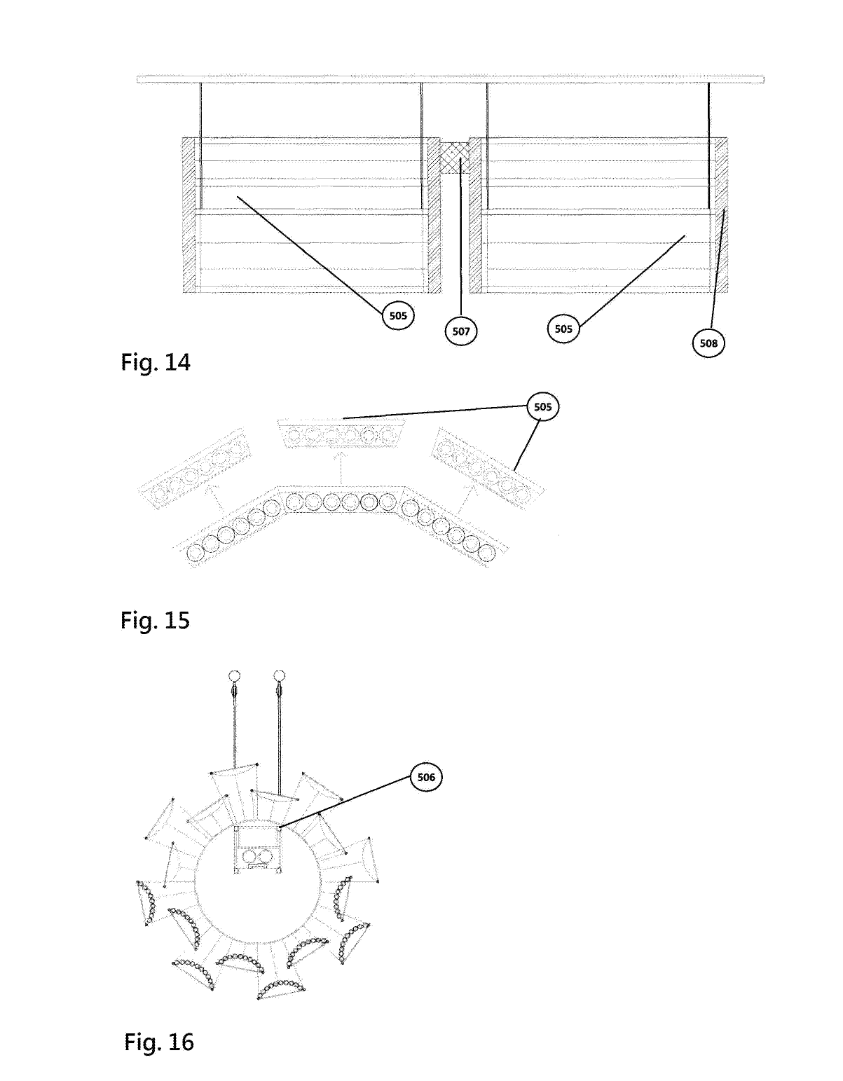

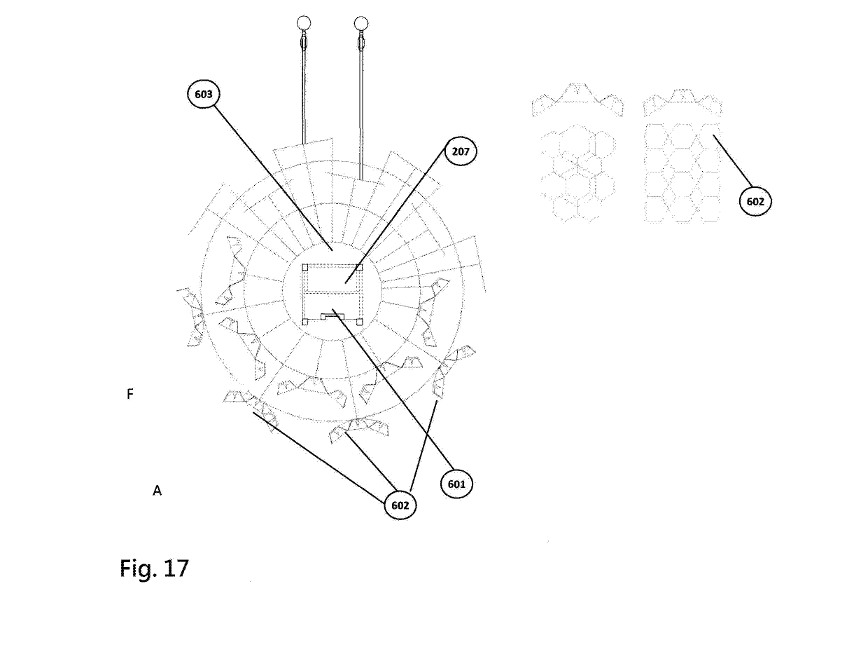

As shown in FIGS. 13, 14, 15 and 16 for the reception solar thermal mechanism that places many receiving pipes (501) on the exterior of a wide radius structure, in order to reach the necessary width for an effective reception of radiation. The figures mentioned show setups that divide the receiver into modular units (500) with structures similar to the receiver used by technologies such as the Fresnel Linear technology. On the other hand, FIGS. 17, 18 and 19 show this option for the photovoltaic mechanism, as well as FIG. 20, which depicts the Stirling engines case.

iii. Modular Receivers in Movable Cabins

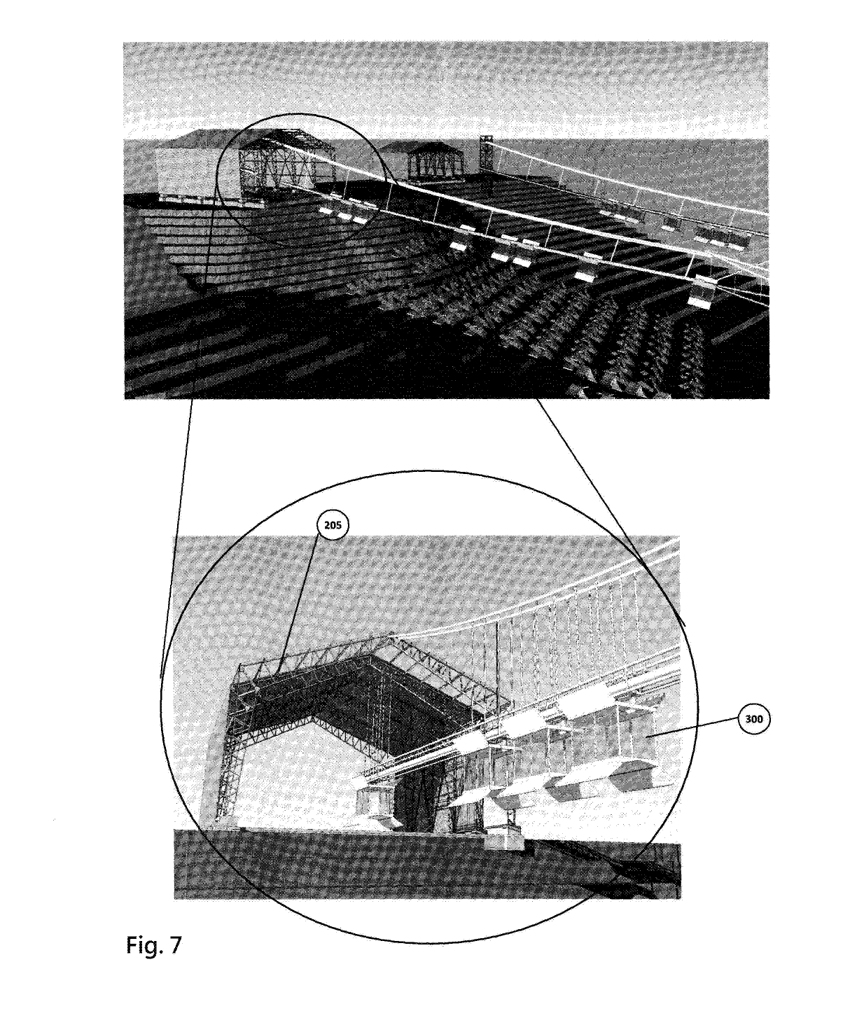

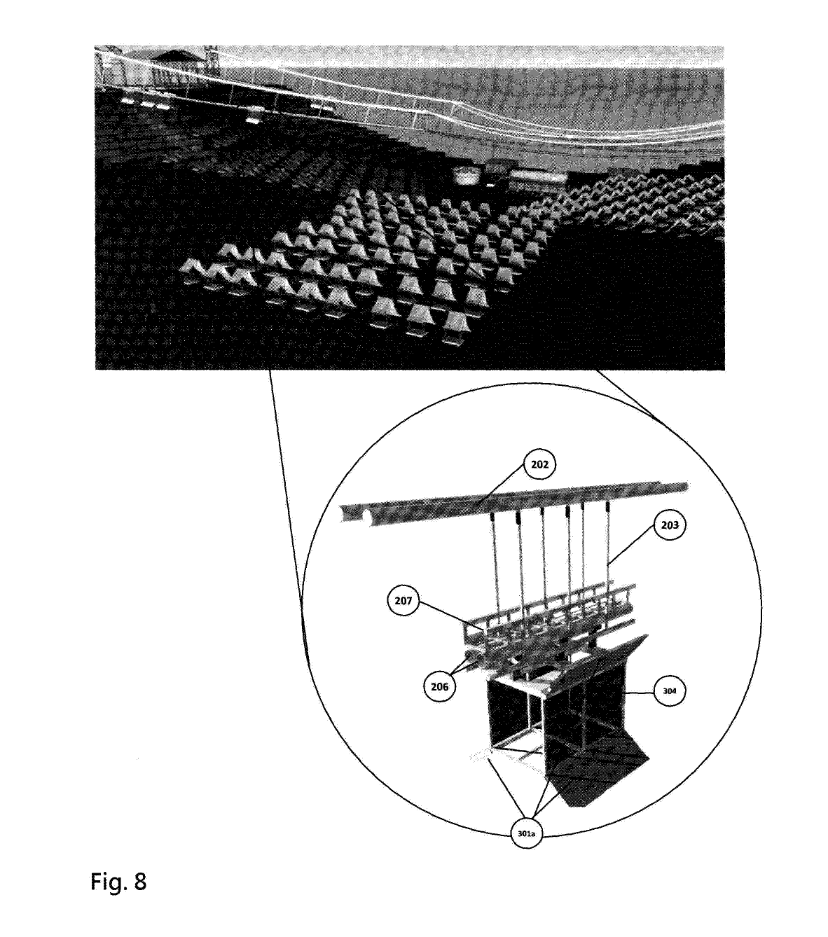

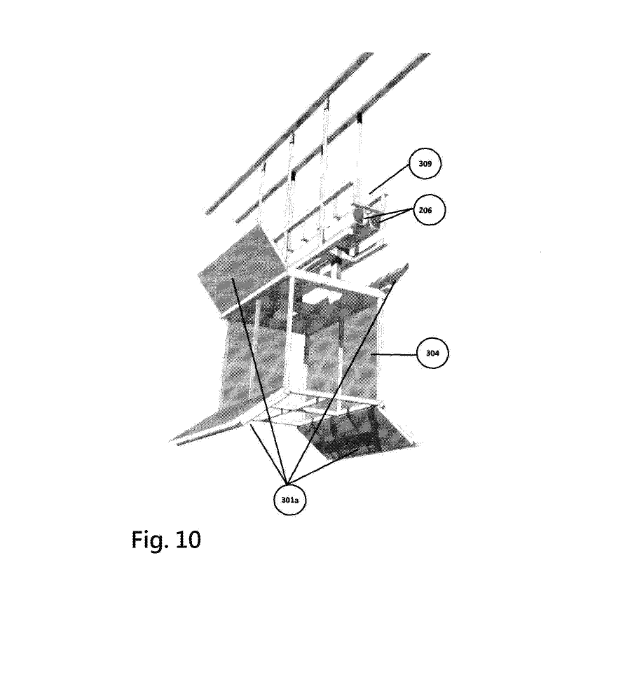

In consists of modular receiving units (FIGS. 7, 8, 9 and 10) placed in funicular-type movable cabins that hang from, and slide though, rails across the bridge. The cabins move while being suspended through anchors that slide with wheels on the rails, as a bridge crane. There is a longitudinal slot between the rails that allows the entry and slide of the cabins suspension anchors. For operational flexibility purposes, it is convenient to count on two rail lines to allow parallel movements to replace and transfer cabins, considering transfer stations between them.

As many cabins as necessary can be included, and some replacement units ca be kept for its maintenance and repair.

Modular receiving units are developed per every reception mechanism, either thermal, photovoltaic or thermomechanical.

The cabins have hermetic lids on both sides and on the floor, which are open throughout the day to receive radiation from collecting webs, which comes from these directions. This lids are open during the day to use them as secondary collectors with reflecting surfaces that redirect overflowing radiation towards the receiving panels.

The displacement mechanism through the suspension rails will allow the transfer of receiving modules to the workshop area for their maintenance. Likewise, it will allow the movement of modules during operations following the position of the sun towards more favorable potions that facilitate the orientation of collectors. The movement of funiculars (FIG. 7) during the day is not continuous and towards regular positions where there are connection mechanisms to the matrix piping along the bridge (faucets or connectors in fixed positions). The cabins can move individually or as a group like a train with many units. A simple procedure for the advancement of receiving modules towards more favorable positions, following the sun, consists on changing, at certain points in time, the back cabin of the group to a forward position, with subsequent operations.

These cabins, as well as the receiving units included inside must be the same, in order to allow exchangeability and serial production to reduce their production cost.

which provide heat through a matrix circuit to a stem plant outside the receiver, as well as units that produce power directly, such as panels or photovoltaic cells or Stirling engines arrangements, which are integrated through a network that transfers production to the booster substation of the plant.

iv. Modular Receptors of Train-cart like movable units.

This option has a similar concept to the funicular-type cabins described in the previous sections, but they count on receiving modules mounted on a train or platform, of one or many carts that slide across a work rail through the hanging bridge.

The radiator system of every cart is built into a piping circuit that feeds both the power system and the storage system, just as the Fixed Receptor options described above.

The train moves across the rail, in order to get to a more favorable position and improve the collectors focus during the day. The train movement can be performed in discrete advancements towards established positions to facilitate their connection to the fluid feeding lines, from the primary hydraulic circuit, which integrates it to the storage and power units.

The connection, as such, just as in the funicular-type cabins case, is performed through faucets placed in a uniform way, along the rail.

c) Receiver executions for each one of the reception mechanisms
i. Thermal receivers

The thermal reception mechanism is related to heat transfer to the generation plant with steam turbines and to the thermal storage option, which maintains production when there is no more solar radiation, at night. The installations to transfer heat to the thermal fluid and take it to the generation plant and the storage tanks are described below.

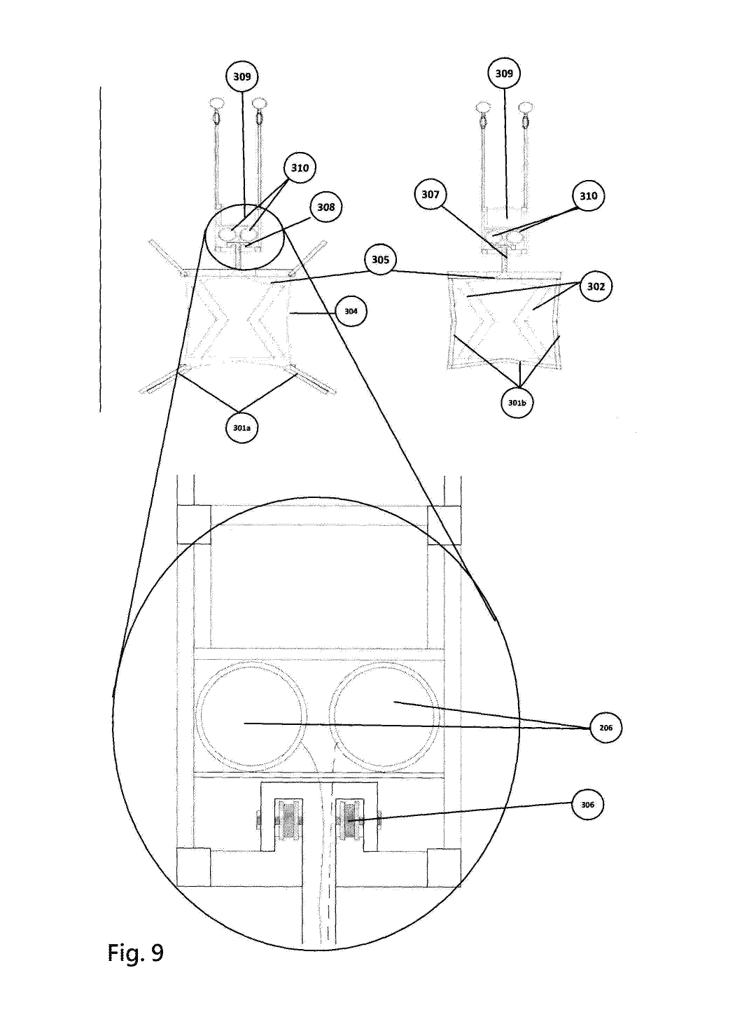

The receiver has been formed with identical and exchangeable modular receiving units in order to simplify its installation, operation, maintenance and manufacturing. This configuration is maintained for all setups described in section b), as follows:
For the mobile cabin option, the modular receptor is inside it; thus, it is similar to the cavity receptors in solar towers that allow a better control of heat losses due to convection. Inside the cabin, on both sides and the bottom, piping panels are installed facing the solar field, encapsulated by a clear cover divided by panel groups, with a rigid isolating wall on the back for its independent thermal isolation (FIG. 9, 302). The panels are joined through collectors that cross the isolating wall and take the fluid to regulation deposits at the center of the cabin, to deliver a uniform flow, at the designated temperature.
For the train-like mobile carts option, the receiver is similar to the cabins one; nevertheless, it is necessary to design a mechanism that takes advantage of the lower radiation.
In the case of the peripheral longitudinal receptor, there is a thermal receiver with longitudinal pipe beams within a secondary collector in modules similar to the receivers used in Fresnel linear technology (FIG. 13, 501), installed on the squirrel cage structure alternatively, on two adjacent external radius, which is installed from the mounting area (510), on the service line of the bridge, using the transport and hoisting means of the bridge, and the rotation ability of the cage-like structure (FIG. 13). The longitudinal pipes at the end of each section are joined together by a circular collecting pipe (508), which also has elements that allows it to join the next section with removable units (507) to replace pipes or collecting modules per section.
For the inner longitudinal receiver with secondary collector, there is a thermal receiver formed by one or several high-flow pipes (401) placed under the service rail of the bridge and at the center of the cage-like structure of the secondary collector. In order to avoid heat losses due to convection, a vacuum area is incorporated (403), around the pipe(s), formed by spaces outlined by circular, clear walls. In this area there is also a longitudinal division in regular angular portions, also with clear walls in a radial direction that separate independent cavities (403) that serve as a support for the cylindrical surfaces and means to distribute the mechanical efforts exercised on these surfaces.
In addition, there is a possibility for the pipe line to be formed by independent sections, in series, joined by anchoring rings that fix them to the bridge. Some of these joints are designed to absorb longitudinal thermal expansions by separating sections, which can also spins around their longitudinal axis while in operation, independently, to improve the transfer of heat to the fluid moving through them. This very movement allows the reduction of thermal gradient between the surfaces that are exposed, and not exposed to solar radiation, around the circumference of every pipe. This movement mat not be required in the case of direct steam generation, as in this case the portion in liquid state will tend to stay in the low area of the pipes, facilitating the evaporation and; thus, the transfer of heat.

The thermal solar receiver of this invention considers the bridge to have at least two matrix pipes (206), one to bring the fluid to the receiver and a hot one to carry it to the generation plant. The bridge counts on an area, under the service rail, to house these pipelines, considering widening clearance areas of the bridge to incorporate compensation areas for thermal expansion.

The cold and hot pipes incorporation is consistent with the fact that the receiver is based on parallel receiving units that simultaneously take the fluid form the cold pipe and deliver it, at the appropriate or designed temperature, to the hot pipe. The option to incorporate matrix pipes of intermediate temperatures to the feed from and to the plant is still considered, at least for some sections, to establish partial heating stages in some modules, with subsequent increase until reaching the delivery temperatures for the plant. In this case, some receiving units must take the fluid from the cold pipe and deliver it with a higher temperature to an intermediate temperature pipe. The follow9ing units take the fluid from the intermediate temperature pipe to deliver it to the final temperature pipe that is sent to the plant. Thus, several heating stages can be establishes by adding several matrix pipes with intermediate temperatures. This division can be especially useful for the direct production of steam, differentiating the pre-heating, vaporization and reheating stages, which are typical characteristics of the steam cycles. This requires the design of modular receivers which are different for every stage and different sections for the matrix pipes related to each.

Additionally, an individual control mechanism for every receiving unit determines the time a fluid remains in each unit, as well as the flow required for the increase of temperature ti be the one designed, in light of several radiation levels received. If a unit is receiving low radiation, the control mechanism will reduce the delivery flow of the fluid, in such a way that it can reach the corresponding temperature. Similarly, if the radiation increases, the mechanism will increase the fluid delivery to avoid excessive temperature increases.

The modular-type layout allows the use of more than one transfer fluid or circuit. As an example, some receiving units could be dedicated to the direct generation of steam for the generation pants and other receiving units could be used to heat melted mineral salts for the storage plant. In this case, there will be some receiving modules used to heat mineral salts and other to generate steam, with such matrix pipes systems installed in the bridge, which can be distributed in separate sections or lines.

In this sense, it is also possible to heat air at high temperatures to feed a Brayton cycle, In this case, the receiver takes cool air and delivers it at high temperature to a high-scale piping system that, in turn, takes it to an external heating turbine that activates the power generator outside the bridge. The exhaust or outgoing air of the turbine can feed a steam cycle as in the natural gas combined cycle plants.

Finally, an interesting option would be to replace the steam plant with a Stirling engines plant fed by heat from a melted salts circuit, either directly from the receiver or the storage ponds. This requires the incorporation of several engines in a series, in such a way that the first engine receives the fluid at the highest storage temperature and the following engines would receive the fluid at the outgoing temperature of the last, some degrees lower, and it delivers it to the next, with a new decrease in temperature, at the end, it is delivered at the cold pond temperature, recovering all the power stored in the thermal fluid, The advantage of this system is that it does no need water for cooling and, as it is modular, its installation can be scheduled according to the increase in the demand curve, also delivering pretty competitive profit.
ii. Photovoltaic Receivers

The application potential of the photovoltaic option using the structures and setup of this invention is pretty wide and some options have been proposed:

Firstly, the option of using the collecting webs directly as support structures for photovoltaic s modules is included, replacing the mirrors with these modules, In this case, the required electric equipment would be added, which include the following: connectors, inverters, the network that allows the junction of contributions from the modules within every web, as well as the network that joins the contribution from all webs, with the required tension boosting substations. Like this, there are higher-scale setups than the existing ones.

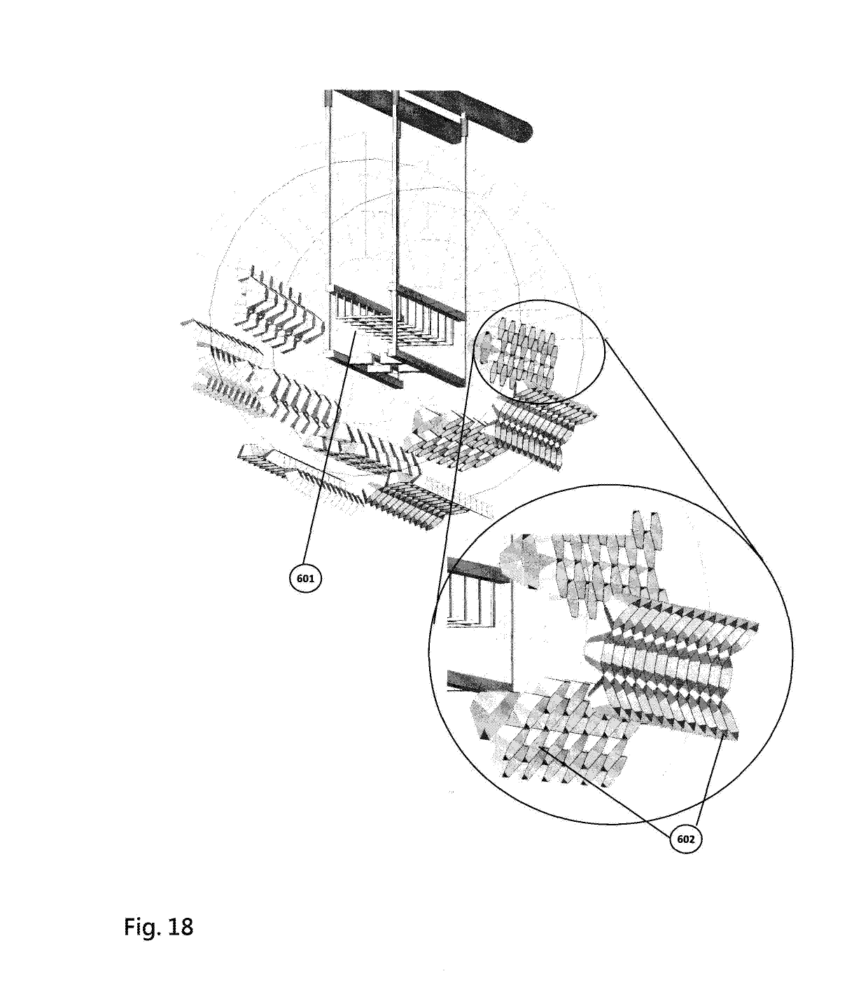

The second option uses the potentiality of the concentration mechanism developed in this invention, installing photovoltaic modules in the receiving bridge (FIGS. 17 and 18). It is worth mentioning that the photovoltaic cells must have enough capacity to receive concentrated radiation coming from the bridge. The cells of several junctures can receive pretty high radiation levels with a concentration factor of over a thousand.

Photovoltaic cells arrangements are established for the four receiver layout options described in section b) with longitudinal peripheral, inner longitudinal with secondary collector, modular in movable cabins and modular in train carts options. Likewise, the substations with inverters, switches and protection elements are considered in the bridge, with a transmission network from the bridge to the boosting substation of the plant. These systems, on the one hand, translate into a significant load for the bridge, as well as de obligation to consider and establish the mounting, replacement and maintenance logistics for its elements, through the common collector bridge. Due to the significant energy concentration in the receptor bridge, the substations mentioned above will be quite close to each other; thus, it is expected that in the tunnel in the intermediate part of the bridge, under the service rail, modular substations are installed with inverters, creating a transport network that links the, with conducting wires to the main substation of the plant, through the bridge.

In practice, the photovoltaic option is different form the thermal option as it replaces the thermal receivers and their thermal fluid conduction piping through the bridge with the photovoltaic arrangements with the substation network and power wires mentioned above, to send the production to the main substation.

The photovoltaic cells arrangements within the layouts has been established considering high-capacity and efficiency cells for high concentration levels. Currently, these features are present in the multiple-juncture cells, which allows a better scale and global efficiency of the plant. FIG. 17 shows the peripheral longitudinal setup with a squirrel cage-like support structure to house the photovoltaic panels on its external area. In this figure, there is a longitudinal optical structure with conic and hexagonal concentration units (602) facing the solar field with a wide entry of radiation through lenses that concentrate radiation and target it to the position of the photovoltaic cells. This structure may not be appropriate for the current devices. We must consider that the receiver receives radiation from several angles and several positions, where the collecting webs are located. This feature is not compatible with the available concentration optics that are targeted to capture direct radiation. In this case, it is anidolic radiation that, even though during the day it maintains its incidence direction, regardless of the position of the sun, it has a disadvantage, the receiver receives radiation from several places with a relatively wide angular range, which is not acceptable for the optics mentioned above. On the other hand, this feature does not require sun-tracking mechanisms. This is because the mirrors of the collecting webs, even if the web spins, do not change their position too much, with regard to the receiver, thus, regardless of the position of the sun, the radiation arrives to the receiver, approximately, from the same places.

The main problem of this condition is that each point of the receiver is receiving incident radiation in a relatively wide incidence angles range, which is a problem when trying to use directly the high-efficiency panels with multiple-juncture cells, as the optic elements used in them restrict the incidence angle around a degree with regard to the vertical. Thus, it is necessary to incorporate some mechanism to make every reception basic unit receive radiation with small angular ranges. As a basic unit, a photovoltaic cell with a small concentration dome can be used, Two radiation differentiated angular collection mechanisms are incorporated which can be complemented to improve results. These mechanisms are described below

The first mechanism developed has been named inner fractal subdivision. This mechanism consists of the division of the reception area, establishing multiple cavities or concave surfaces on it, in such a way that every superficial portion within the cavity receives radiation form specific directions and narrower angular ranges. Building new small cavities within these first level cavities produces a second superficial division in which each side of every small cavity becomes more specific, facing radiation with smaller angular ranges. In order to avoid superficial losses, hexagonal cavities are established in order to maximize the radiation collection on the panel or receiving module.

A way to establish these cavities is by placing alternate layers at different heights, in which concentric reception areas of subdivisions in groups of 3 receiving cavities (602) are alternated. The middle area is deeper, and the two lateral areas are tilted in such a way that each one of them is perpendicular to the mean radiation it is facing. Each one of the receiving units will receive radiation with narrower angles than the ones in its group, If each one of the three units is subdivided into three subunits, there will be a greater reduction of the angular band received. Subsequent subdivisions will reach acceptable ranges for each photovoltaic cell. Thus, the receiving surfaces in the inner line will always receive a narrower radiation range, as the one related to wider angles is captured by the neighboring surfaces and the outer ones. Thus, replicating the design and arrangement of the photovoltaic cells areas described in FIG. 17 with new subdivisions in inner layers, in a reiterative, fractal way, will subsequently reduce the incident radiation ranges in each one of the reception units. This structure will be longitudinally reproduced acquiring the shape shown in the tridimensional view in FIG. 18. For more subdivisions, every row of conic cavities will be broken down into 3 prior roes. Alternatively, longitudinal cavities like gutters or a series of hexagonal cavities can be considered to reach the required lengths. The first option is appropriate if the angular scattering in a longitudinal direction is low and within the acceptable range. The second option is mandatory id the angular radiation scattering is higher than the acceptable range.

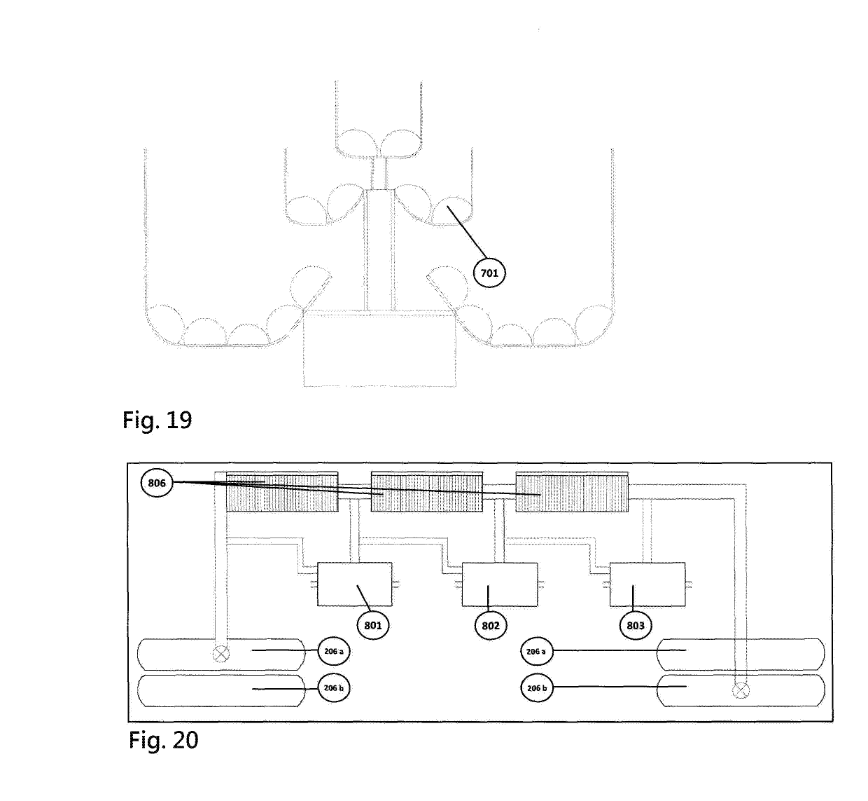

The second radiation differentiated angular collection mechanism has been named central fractal subdivision, its shape is the one shown in FIG. 19. It is installed in the external surface of the collection panel. This mechanism is applied to arrangements or panels installed on the squirrel cage of the peripheral longitudinal receiver, in the cabins or carts or inside the secondary collector. It uses a fractal repetition mechanism similar to the previous one, in which every structure has a cavity with a higher central part, in which the same structure us repeated, with a new cavity inside, in a reiterative way. The basis is an arrangement that contains an upper central receiver and two lateral ones with reflecting surfaces on the walls of the whole structure, The upper central receiver is also subdivided into an upper receiver and two lower lateral ones with a smaller size, The smaller receiver accepted corresponds to a photovoltaic cell with a small concentration dome around it (701), which are repeated on the upper and the lower lateral positions. The arrangement described can be developed in circular, hexagonal or other areas, with an upper circular part and a lower part around it. The upper circular one is also divided into an upper circular one and a lower circular one. Any diametric cut will looks as FIG. 19. The same for the hexagonal case.

In a mixed design, a combination of both mechanisms described above can be chosen until reaching the angular band with required for each radiation reception dome.

iii. Thermomechanical Receivers with Stirling Engines

The solar radiation high concentration in the Common Receiving Bridge make it possible to use Stirling engines as a reception means with much higher capacity than the ones used in parabolic dishes.

The engine-generators groups can be placed, with no parabolic dishes, directly on the bridge according to any arrangement presented as an execution of the receiver in section b), that is: in a peripheral longitudinal position, an inner longitudinal position with secondary collector, the modular options with funicular-like cabins and the modular option with train carts. Due to the high incident radiation, a great amount of engines per linear meter of the bridge would be required, which would have to be distributes on the outer area. A good options could be to install the, in reflecting hexagonal cones (602) joined on their edges, forming longitudinal cylindrical surfaces with an appearance similar to the structures in FIG. 18. Every cone has the function of increasing the collection surface to a slightly wider radius than the engine housing, in order to prevent radiation from overflowing and have an influence on it.

In the case of movable cabins arrangement, they are installed in a similar way, with a receiving cavity towards the solar field, with the sizes available many are needed, each one on each side of the cabin and some other downwards to receive radiation coming from these directions. The reception cone must cover a wider area than the housing of each engine, to avoid radiation losses and damage to the equipment.

This arrangement is intensive in generating units that are relatively small for the production scale, which presents some challenges for its operation and control, so it is necessary to develop bigger engines to reduce the operation complexity. Likewise, due to scale economy reasons, it would be convenient to use bigger engines, but the Stirling engines market has had a slow development, in comparison to the internal combustion engines that burn fossil fuels and there are no engines available with the appropriate size. Currently, the Stirling engines used for parabolic dishes have a capacity of around 25 kW. The design with the greatest size known, that uses these engines, is 600 kW, which is very old and there are no units in the current market for this design. The greatest commercial sizes are the ones used in submarines with sizes of 775 kW, but they have to be adapted to this application.

The invention herein opens a market that would allow the development of larger-sized engines with some special constructive features for this application. As an example, it is worth considering units with more pistons in a common axis, operated by heat sources at several temperatures to differentiate 3 or more heat transfer stages, as in the turbines, with high, intermediate and low temperature stages, This specification is adjusted to the design of this invention, which considers thermal storage in melted salts ponds. In this case, it is necessary to improve the heat transfer mechanism between the thermal fluid and the internal operation gas of engines. In this case, it is better to use a thermal receiver to heat melted mineral salts and feed the engines either form the receiver or from the storage pond. After the radiation period of the day is completed, the thermal fluid flow is inverted to feed the engines from the storage ponds. Here, the flow goes from the high-temperature stage, which extracts part of the energy contained, then the fluid goes at a lower temperature from the medium stage, where it delivers another portion of this energy and, finally, to the low temperature stage, delivering the rest of the energy contained to the generation mechanism.

An alternative to this design would be considering several engines in a series (FIG. 20), each one working at a different temperature where each engine (801, 802, 803) delivers the fluid to the next, at a lower temperature that the one received. It is worth considering that, in any of these modalities, there is a loss, as efficiency is maximized for high temperature, but in order to rescue all energy stores, we must consider stages with successively lower temperatures, up to the minimum acceptable for the fluid used. This efficiency reduction leads to the measurement of the solar field size in order to compensate the loss of related energy. Even if this effect is considered, the mean efficiency of the system as a whole is pretty high, in comparison to the one obtained from other technologies.

According to the descriptions in the invention herein, a mechanism to use thermal storage with melted salts to feed Stirling engines has been established, at night or during period where radiation is interrupted. During the day, the thermal receiver (806) simultaneously operates by feeding the Stirling engine directly and storing a portion of the radiation received as heat in a thermal fluid, which is removed from a cold pond to then return it after being heated to a second high-temperature pond. At night, fluid from the hot pond is extracted (206a) in order to return it after it has been chilled (206b) once it is used as a heat source for the engines. The receiver then, in any of its positions, must consider the direct use of heat, as Stirling engines, and the transfer of such heat to a thermal fluid, for storage.

The receiver with Stirling engines in the bridge must be economically comparable to the option of keeping thermal receivers in the bridge and transferring fluid to feed Stirling engines in a plant outside the bridge. When directly incorporating the engines to the receiver, the matrix pipes do not have to be that big, as a portion of the heat is used for direct generation, escaping through the electric network. On the other hand, for a plant outside the bridge it is necessary to measure the pipes to transfer all the fluid required for storage simultaneously with the fluid required for generation in the plant, during the day. The best option depends on the site, the size of the plant and the bridge, as well as the consumption characteristics and the whole network.

A significant advantage of Stirling engines, regarding a steam plant, is that this generation system does not require any cooling, thus, water consumption is restricted to the use of staff services and mirror washing, which is a significant advantage for its application in many sites.

iv. Mixed Receivers with Photovoltaic Panels, Thermal and Thermomechanical Receivers in the Common Receiver Bridge

In some situations, applications that imply a complementary or mixed use of the reception and storage mechanisms available can be convenient. As an example, with the efficiency currently reached, it could be convenient to use the base radiation in thermal modality and leaving eventual radiation or more intermittent radiation for the photovoltaic modality In this option, it would be necessary to dedicate differentiated portions of the bridge to every generation type.

C) Centralized Control System for Collectors and the Receiver

A sun-tracking system will allow the optimization programs to command the position of the actuators that will adjust the orientation and shape of collectors to reach an appropriate focus at all times. In the case of mobile receivers, this very central control will coordinate the receiving cabins movements and the movements of collecting webs, as well as the thermal fluid flows through the circuits to the power system and the storage system.

A communication system between receiving units and collecting webs is considered so that the collector can detect any position changes in the receiving module to update the radiation focus. This requires every collection unit to emit a special sign that can be identified and interpreted by the collection web control.

1. Solar generation system to substantially improve the scale and efficiency of steam production and electricity, which includes collecting units; thermal receiving units, photovoltaic or thermomechanical; steam turbines power units, photovoltaic and Stirling engines; thermal fluid storage ponds; electric power storage units; heat exchangers; steam generation units; substations and network connection equipment, supply infrastructure, supports and anchors characterized by being formed by:
Wire or chains network armor for anchoring one or several solar collectors or receivers, in the form of extended webs hanged fro, a spinning structure, at height, tightened fro, the lower part from a distant horizontal bar fixed to a movable anchoring structure on a circular rail with low altitude, where there is also a washing unit for collecting or receiving units;
Hanging collectors with mirrors or reflecting surfaces following the transversal cords of a wire or chains network armor, in the form of an extended web;
Hanging or anchored receivers following the transversal cords of a network armor, in the form of an extended web:
Bridges to support large-scale thermal, photovoltaic or Stirling engines receivers at height with structures and anchors on the ground the include room for equipment and installations, a transit road for staff and material transfer carts, washing cart, matrix pipes to conduct thermal fluid and evacuation and electricity transport networks;
Support structure in the bridge to anchor receivers with thermal, photoelectric and thermomechanical collection mechanisms;
Longitudinal high-concentration and scope receiver, with receiving units with thermal, photoelectric or thermomechanical collection mechanisms, at height, distributed across modular structures on support bridges, longitudinally placed on the solar field
Great breath secondary modular collector with double-reflecting-surface mirrors in radial direction for longitudinal inner receivers, placed around such receivers, and mounted on a concentric cylindrical structure that supports mirrors with a wire network, which comes closer for the replacement and washing with a mobile washing unit that moves through the bridge with windows towards the mirror lines;
Matrix piping for the conduction of thermal fluid and connection faucets on them ,placed at regular distances across the pipes to feed modular receiving units;
Power network for the evacuation of electricity generation production on the bridge;
A software specifically created to direct the solar plant operations, which receives the information captured by measuring, detection and communication instruments specifically placed to synchronize the movement of collecting units with the movement of solar generation system reception modules while tracking the apparent movement of the sun on the solar field.

2. Solar generation system, according to claim 1, characterized by a spinning structure where collecting webs hang as a double portal supported by a spinning base in which each portal is formed by two or more columns joined by bars on their upper end.

3. Solar generation system, according to claim 1, characterized by longitudinal cords of the armor of the collecting web joined on their ends to close the surface around itself and move it with a mechanism in the form if a conveyor belt through rollers on the lower horizontal bar and the horizontal bars of the double-portal from which the collector webs hangs.

4. Solar generation system, according to claim 1, characterized by a surface washing unit for the collecting web which works automatically, acting on the web's movement mechanism through drive rollers to bring the series of mirrors and receptors closer, one by one, so they can be washed, subsequently, in regular intervals during operation.

5. Solar generation system, according to claim 2, characterized by a double portal formed by two parallel portals mutually separated and tilted towards each other, with variable openings, in such a way that their respective sides are crossed and open in a scissor-like manner both mounted on a common spinning base.

6. Solar generation system, according to claim 1, characterized by a double portal with a mechanism to regulate its opening with electric motors and hydraulic actuators incorporated to the columns of both portals, reach acting on the position of the respective column of the other portal, adjusting the crossing point.

7. Solar generation system, according to claim 2, characterized by both portals being able to modify their height by elongating their columns with a hydraulic mechanism.

8. Solar generation system, according to claim 2, characterized by both portal being tubular with lateral columns that expand as they are formed by several steel pipes, which move inside of each other, elongating the column and, hence, the portals, through a hydraulic system.

9. Solar generation system, according to claim 2, characterized by horizontal bars on the double portal that can project to both sides of the portal and support such collector webs during extensions, moving alongside the webs, supported on the interior of the portal.

10. Solar generation system, according to claim 1, characterized by the collecting web armor having transversal tubes in certain positions, which carry some heavy fluid that is loaded or removed by pumps fro, a storage pond, commanded by the control system, whenever the catenary shape, which is naturally acquired by the web us to be modified.

11. Solar generation system, according to claim 1, characterized by the surfaces of the collecting webs being formed by reflecting surfaces elements, not necessarily mirrors,

12. Solar generation system, according to claim 1, characterized by a radiation receivers support bridge consisting of a hanging bridge of great length that extends at height from hills or from structures, through supporting wires suspension towers and robust anchors.

13. Solar generation system, according to claim 1, characterized by a hanging bridge supported by cords in catenary that support vertical suspended wires at regular distances, which support structural bridge arches, which define free sections where the transit road is located, with one or two-way rails for the transfer of trains with reception modules, carts with people or material in the upper part, anchoring structures for matrix piping, foe substations and evacuation networks, un a longitudinal tunnel, on its mean portion, and movement mechanisms for cabins containing receiving module on the lower part.

14. Solar generation system, according to claim 1, characterized by structures that support radiation receivers on the bridge, which are cabins that move while hanging from the bridge, designed for this application, which move through the bridge rail to stations separated at regular distances according to a temporary program, to adapt to the position of the sun throughout the day.

15. Solar generation system, according to claim 14, characterized by the lids of the cabins carrying receivers that open during the day to use them as secondary collectors with reflecting surfaces that redirect overflowing radiation towards receiving panels.

16. Solar generation system, according to claim 14, characterized by hanging cabins containing receiving units, which are attached to wires pulled by a traction mechanism that transports the, through guiding rails form the bridge to separated fixed positions at regular distances and up to the maintenance workshops.

17. Solar generation system, according to claim 1, characterized by the structure to support radiation receptors on the bridge being a train of carts that move through the bridge, some motorized, designed for this application, to separated stations at regular distances, according to a temporary program, to adapt to the position of the sun throughout the day.

18. Solar generation system, according to claim 17, characterized by train carts that expose modular receptors through wide windows that dose at night and open during the day with walls operating as secondary collectors with reflecting surfaces.

19. Solar generation system, according to claim 1, characterized by a radiation receivers support structure on the bridge being a modular structure, with separated longitudinal bars on the perimeter of an inner radius circumference and the same number of bars on a different external radius, squirrel-cage type, to support several kinds of receivers or support the secondary collector on the outer area of each free section or span of the bridge.

20. Solar generation system, according to claim 19, characterized by a squirrel-cage structure that supports receiving modules that spins through rings that slide through rails around the bridge, bringing the receiver and secondary collector parts closer to a mounting and replacement are located on the bridge rail.

21. Solar generation system, according to claim 19, characterized by a receiver located under the bridge rail, surrounded inside a secondary collector residing in the squirrel-cage structure.

22. Solar generation system, according to claim 19, characterized by a secondary collector mounted on the squirrel-cage type structure, in which the reflecting double-faced mirror lines are supported, in a radial direction, between the inner area bars and the outer area bars of the cage.

23. Solar generation system, according to claim 19, characterized by cleaning of secondary collector mirrors being performed with a mobile washing unit that goes through the bridge rail, with windows towards the mirror lines, using the rotation mechanism of the squirrel cage structure to bring the mirror lines close to the washing area.

24. Solar generation system, according to claim 1, characterized by a bridge with lightening and strength, water and compressed air (for cleaning) circuits installed in its structure.

25. Solar generation system, according to claim 1, characterized by a bridge which, in the lower portion of it structure, count on bridge-crane type rails fro, which cabins carrying receiving modules hang.

26. Solar generation system, according to claim 1, characterized by a bridge that counts on rails with a wide longitudinal slot between the, which opens downwards to allow the access of suspension anchors from which cabins carrying receiving modules hang. Such anchors count on wheels under their arms which allow the, to slide on the rails.

27. Solar generation system, according to claim 1, characterized by a longitudinal high-concentration and scope receiver consisting of a thermal receiver of groups of pipes panels, placed in the movable cabins, through which a thermal fluid circulates, facing the solar fields. Some on one side and others on the bottom of the cabin, encapsulated and thermally isolated from each other with a clear wall towards such solar field and a rigid wall on the back, towards the inside of the cabin, which serves as anchoring and support of collector ponds connected to matrix conduction piping through valves, pumps and faucets.

28. Solar generation system, according to claim 1 characterized by a high-concentration and scope longitudinal receptor consisting of a thermal receiver if groups of pipe panels, placed in the train carts, which carry thermal fluid, facing the solar field. Some on each side of the cart, encapsulated and thermally isolated, with a clear wall facing such solar field and a rigid wall on the back, towards the inside of the cart, which serves as anchorage and support of collects ponds connected to the matrix conduction pipes through valves, pumps and faucets.

29. Solar generation system, according to claim 19, characterized by receiving units at height, formed by thermal receiving modules formed by longitudinal absorption pipe beams per sections, within an armor with thermal isolation and a common transparent wall towards the solar field, on the outer part of the squirrel-cage.

30. Solar generation system, according to claim 29, characterized by pipes of the receiving modules joined to circular collecting pipes on the edges, which are connecter to the faucets of the bridge's matrix pipes for their supply, through valves and pumps.

31. Solar generation system, according to claim 19, characterized by receiving modules placed on the squirrel cage structure in two proximal levels, an outer and an inner one, alternatively, with free room for wind to pass between them.

32. Solar generation system, according to claim 1, characterized by a longitudinal receiver inside the secondary collector, composed by pipelines across the bridge through which a thermal fluid flows, which enters at a low temperature and increases its temperature when receiving radiation, across the pipes, until reaching the designed values.

33. Solar generation system, according to claim 1, characterized by lines of receiving pipes located inside a longitudinal and concentric secondary collector that redirects incident radiation to the inside, where receiving pipes are located, avoiding a radiation overflow, to increase collection with a bigger equivalent reception area.

34. Solar generation system, according to claim 33, characterized by receiving pipelines supported by clamps or solid metallic bands fixed to the bridge, separated in sections connected through hermetic junctures that allow the absorption of thermal expansion and which eventually spin independently from one another, with barbs or prominences inside in a diagonal direction that rotate the pipe section according to the fluid inside it.

35. Solar generation system, according to claim 33, characterized by receiving pipes and a secondary collector with a clear double and divided cover which outlines empty spaces that provide thermal isolation to the receiver.

36. Solar generation system, according to claim 1, characterized by thermal modular receivers extracting thermal fluid from the cold matrix pipe, which then return it, at a higher temperature, to the restitution pipe to the plant and the storage pond.

37. Solar generation system, according to any claim 1 characterized by a thermal fluid circulating through the absorption pipes that can be any transfer fluid, melted mineral salts or water.

38. Solar generation system, according to any claim 1 characterized by receiving modules or units that count on a temperature regulation mechanism that controls the thermal fluid flow extracted from matrix pipes to deliver it at the designed temperature, through valves and pumps.

39. Solar generation system, according to any claim 1 characterized by a thermal fluid circulating through the absorption pipes constituted by air in some or all receiving units to feed a Brayton cycle and then a Rankine steam one.

40. Solar generation system, according to any claim 1 characterized by a receptor constituted in photovoltaic receivers modules placed either in cabins, train carts, the squirrel cage or inside the secondary collector, connected to the substation network of the longitudinal tunnel of the bridge.

41. Solar generation system, according to any claim 1, characterized by receiving modules constituted by photovoltaic cells arrangements grouped in longitudinal and transversal series covering the surface of the receiving muddle.

42. Solar generation system, according to any claim 41, characterized by having photovoltaic cells inside the arrangements, placed in rectangular or hexagonal cavities with photovoltaic cells in concentration domes, or without them, in supporting and scattering basis on the bottom and the sides of the cavity.

43. Solar generation system, according to any claim 41, characterized by receiver longitudinal arrangements with photovoltaic cells that are placed in seta of 3 groups, a set placed in an inner position and another one on the outside, alternatively, in which the central group of the set is deeper and the two lateral ones are tilted to face radiation and each group is subdivided in the same way, in 3 subgroups and so on, subdividing until the radiation received in the smaller inner units have an angular width according to the acceptable angular width for the cell or photovoltaic unit.

44. Solar generation system, according to any claim 41, characterized by having cells inside the cells, which are arranged in concentric rings or diamonds, one after the other, with a central area, which protrudes at an upper level, where cells arranged in rings or concentric diamonds are next to each other, repeating the same grouping form of the previous level.

45. Solar generation system, according to any claim 1, characterized by receiving units consisting of Stirling engines that directly receive radiation, placed in movable cabins, train carts, the squirrel cage or inside a secondary collector, connected to the evacuation networks of the longitudinal tunnel of the bridge.

46. Solar generation system, according to any claim 1, characterized by receiving modules consisting of Stirling engines installed on the bridge, which are used as a heat source if a thermal fluid captured by a thermal receiving module placed either in movable cabins, train carts, the squirrel cage or inside the secondary collector.

47. Solar generation system, according to any claim 1, characterized by a thermal receiver that feeds, with a hot fluid, several Stirling engines in a series, where every engine receive the fluid of the previous one, extracting a portion of the stored power, until the last one closes the loop by returning the fluid, at the lowest temperature designed, to the thermal receiver so it is heated again.

48. Solar generation system, according to any claim 1, characterized by a thermal receiving module feeding both the Stirling engine and the matrix pipes that carry fluid to the storage ponds.

49. Solar generation system, according to any claim 48, characterized by inverting the flow, at night, to feed Stirling engines with the heat from the fluid stored in the hot pond.

50. Solar generation system, according to any claim 1, characterized by the use of Stirling engines designed with several pistons fed in a series with heat stored in a thermal fluid.

51. Solar generation system, according to any claim 1, characterized by a power plant, located outside the receiving bridge, which is constituted by several units formed by groups of Stirling engines, fed in series, with the heat of a thermal fluid stored in the hot pond, returned to the cold fluid pond,

52. Solar generation system, according to any claim 1, characterized by the inclusion, in a single plant, of photovoltaic, solar-thermal and Stirling engines generation in different ratios, installing every type of collectors in specific sectors of the bridge.

53. Solar generation system, according to any claim 1, characterized by the inclusion in a single plant of photovoltaic and solar-thermal generation, installing photovoltaic panels in a portion of the surfaces of some collecting webs.

54. Solar generation system, according to any claim 1, characterized by the sides of the upper part of the bridge counting on photovoltaic panels that capture the overflowing radiation of the solar-thermal receivers.

55. Solar generation system, according to any claim 1, characterized by a generation mechanism consisting of photovoltaic panels placed on the collector webs wire armor, which are connected to a substation network with inverters, switches and control mechanisms that feed the main substation of the generation plant.

56. Solar generation system, according to any claim 1, characterized by the inclusion of optimization programs that command the position of the actuators to adjust the orientation and form of the collectors and focus them towards the receiver, at all times, following the position of the sun, maximizing the collection and transformation of solar power into electric power.

57. Solar generation system, according to any claim 1, characterized by the inclusion of signaling mechanism for each collector to detect the position and target the receiving module assigned by the optimization software, which coordinates and controls the general displacement of collector webs and the reception modules while following the sun.
